(19) United States
(12) Patent Application Publication
(10) Pub. No.: US 2008/0150675 A1
(43) Pub. Date: Jun. 26, 2008

(54) RADIO COMMUNICATION APPARATUS AND RADIO COMMUNICATION METHOD

(75) Inventors: Tatsuma HIRANO, Tokyo (JP); Masahiro Takagi, Tokyo (JP); Tomoko Adachi, Urayasu-Shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Kabushiki Kaisha Toshiba, Tokyo (JP)

(21) Appl. No.: 11/853,437

(22) Filed: Sep. 11, 2007

(30) Foreign Application Priority Data
Dec. 26, 2006 (JP) 2006-349872

(51) Int. Cl. G05B 19/00

(52) U.S. Cl. 340/5.1

(57) ABSTRACT

A radio communication apparatus according to an embodiment of the present invention is a radio communication apparatus that performs radio communication with another radio communication apparatus. The radio communication apparatus includes: a frame receiving unit configured to receive a frame including one or more data frames, from the another radio communication apparatus; a memorizing unit configured to be capable of securing two or more receipt confirmation information memorizing areas, each of the receipt confirmation information memorizing areas being a memorizing area for memorizing receipt confirmation information of the frame and being a common memorizing area for memorizing receipt confirmation information of frames from plural radio communication apparatuses; a discard judging unit configured to judge whether the receipt confirmation information memorized in the memorizing unit is discarded, and to select a receipt confirmation information memorizing area from which the receipt confirmation information is discarded; and a discard controlling unit configured to discard the receipt confirmation information from the receipt confirmation information memorizing area.

### CROSS REFERENCE TO RELATED APPLICATIONS

This application is based upon and claims the benefit of priority from the prior Japanese Patent Application No. 2006-349872, filed on Dec. 26, 2006, the entire contents of which are incorporated herein by reference.

### BACKGROUND OF THE INVENTION

1. Field of the Invention

The present invention relates to a radio communication apparatus and a radio communication method.

2. Background Art

IEEE802.11 is widely known as a wireless LAN standard. One of prospective candidates of a wireless LAN standard in the next generation is IEEE802.11n, which targets throughput exceeding 100 Mbps.

In IEEE802.11n, as a method of holding a bitmap (receipt confirmation information) for selective retransmission, a partial state bitmap and a full state bitmap are defined. It is required for an 11n terminal (a terminal conforming to IEEE802.11n) to have at least one partial state bitmap (“Part 11: Wireless LAN Medium Access Control (MAC) and Physical Layer (PHY) specifications: Amendment: Enhancements for Higher Throughput”, IEEE P802.11n/D1.0 March 2006). When a full state bitmap scheme is adopted, the 11n terminal needs to hold full state bitmaps of all data types (TIDs), for all terminals which the 11n terminal is to communicate with. Therefore, when it is attempted to realize the 11n terminal capable of coping with the full state bitmap scheme and capable of coping with a large number of terminals and a large number of data types, a large number of bitmap memorizing areas (receipt confirmation information memorizing areas) are required in the 11n terminal. As a result, the circuit size of a memory circuit for the bitmap memorizing areas increases.

JP-A 2005-341441 (KOKAI) discloses an example of a terminal that is adopted a partial state bitmap scheme. In the terminal, since bitmap memorizing areas are shared, it is unnecessary to hold partial state bitmaps of all data types for all terminals which the terminal is to communicate with. Therefore, since the terminal can cope with a large number of terminals and a large number of data types using a small number of bitmap memorizing areas, the circuit size of a memory circuit for the bitmap memorizing areas is suppressed.

With regard to such a terminal, a problem is how to deal with a case where all the bitmap memorizing areas are filled with bitmaps. In this case, even if it is necessary to hold a new bitmap, since there is no free bitmap memorizing area, the terminal cannot hold the new bitmap. Under the rules of IEEE802.11n, in such a case, the terminal may discard a bitmap from any one of the bitmap memorizing areas and hold the new bitmap in a freed bitmap memorizing area. Since such a situation may occur, under the rules of IEEE802.11n, when the 11n terminal does not hold a bitmap corresponding to a received receipt confirmation request frame, the 11n terminal returns a receipt confirmation response frame in which a bitmap for requesting retransmission of all frames is included. Therefore, it is likely that retransmissions of data frames are frequently performed depending on whether the 11n terminal holds bitmaps corresponding to receipt confirmation request frames. Other methods of dealing with the case are not prescribed in IEEE802.11n and are not described in JP-A 2005-341441 (KOKAI).

JP-A 2006-33019 (KOKAI) discloses a method of opening a buffer memory for received data, in accordance with prioritization based on QoS (Quality of Service) information at the time of the establishment of a call in an HSDPA scheme. However, this method is a method concerning a buffering of the received data itself. The method is substantially different, in an information memorizing method and information to be memorized, from bitmap management for handling information about whether data frames are received or not.

### SUMMARY OF THE INVENTION

An embodiment of the present invention is, for example, a radio communication apparatus that performs radio communication with another radio communication apparatus, the radio communication apparatus including:

a frame receiving unit configured to receive a frame including one or more data frames, from the another radio communication apparatus;

a memorizing unit configured to be capable of securing two or more receipt confirmation information memorizing areas, each of the receipt confirmation information memorizing areas being a memorizing area for memorizing receipt confirmation information of the frame and being a common memorizing area for memorizing receipt confirmation information of frames from plural radio communication apparatuses;

a receipt-confirmation-request-frame receiving unit configured to receive a receipt confirmation request frame for requesting receipt confirmation of the frame, from the another radio communication apparatus;

a receipt-confirmation-response-frame creating unit configured to create a receipt conformation response frame for responding to the receipt confirmation request frame, using the receipt confirmation information memorized in the memorizing unit;

a receipt-confirmation-response-frame transmitting unit configured to transmit the receipt confirmation response frame to the another radio communication apparatus;

a discard judging unit configured to judge whether the receipt confirmation information memorized in the memorizing unit is discarded, and to select a receipt confirmation information memorizing area from which the receipt confirmation information is discarded; and

a discard controlling unit configured to discard the receipt confirmation information from the receipt confirmation information memorizing area.

Another embodiment of the present invention is, for example, a radio communication method executed by a radio communication apparatus that performs radio communication with another radio communication apparatus, the radio communication method including:

receiving a frame including one or more data frames, from the another radio communication apparatus;

memorizing receipt confirmation information of the frame in a memorizing unit, which is configured to be capable of securing two or more receipt confirmation information memorizing areas, each of the receipt confirmation information memorizing areas being a memorizing area for memorizing receipt confirmation information of the frame and being a common memorizing area for memorizing receipt confirmation information of frames from plural radio communication apparatuses;

receiving a receipt confirmation request frame for requesting receipt confirmation of the frame, from the another radio communication apparatus;

creating a receipt conformation response frame for responding to the receipt confirmation request frame, using the receipt confirmation information memorized in the memorizing unit;

transmitting the receipt confirmation response frame to the another radio communication apparatus;

judging whether the receipt confirmation information memorized in the memorizing unit is discarded, and selecting a receipt confirmation information memorizing area from which the receipt confirmation information is discarded; and

discarding the receipt confirmation information from the receipt confirmation information memorizing area.

### BRIEF DESCRIPTION OF THE DRAWINGS

FIG. 1 is a system diagram of a radio communication system;

FIG. 2 is a functional block diagram of a radio communication apparatus;

FIG. 3 is a sequence chart concerning a first specific example of radio communication processing;

FIG. 4A represents an example of a frame structure of a block ack request frame;

FIG. 4B represents an example of a frame structure of a block ack frame;

FIG. 4C represents an example of a frame structure of a QoS data frame;

FIG. 4D represents an example of a frame structure of an A-MPDU sub-frame;

FIG. 5 is a sequence chart concerning a second specific example of the radio communication processing;

FIG. 6 is a sequence chart concerning a third specific example of the radio communication processing;

FIG. 7 is a sequence chart concerning a fourth specific example of the radio communication processing;

FIG. 8 is a sequence chart concerning a fifth specific example of the radio communication processing;

FIG. 9 represents an example of a correspondence table of a ranking of data based on QoS information; and

FIG. 10 is a flowchart concerning processing in 5-1.

### DESCRIPTION OF THE EMBODIMENTS

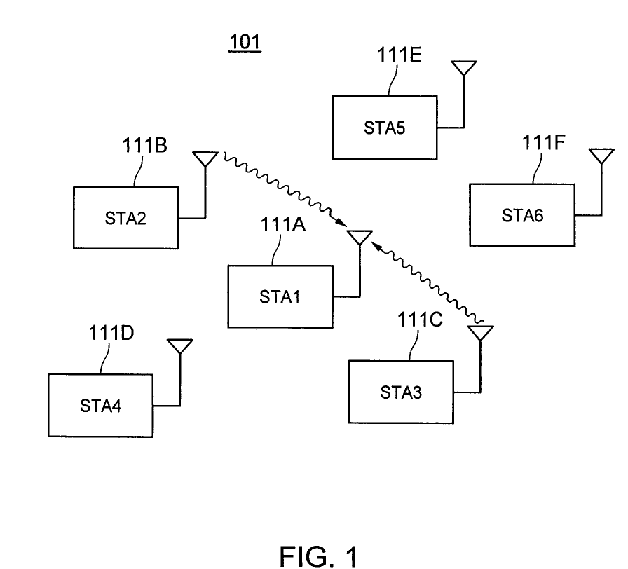

FIG. 1 is a system diagram of a radio communication system 101. The radio communication system 101 includes plural radio communication apparatuses 111 that perform radio communication with one another. Each of the radio communication apparatuses 111 performs radio communication with another radio communication apparatus 111. It is assumed here that these radio communication apparatuses 111 are radio communication apparatuses conforming to IEEE802.11n. The radio communication apparatuses 111 are distinguished by alphabets affixed to reference numerals, such as 111A, 111B, 111C, and the like. The radio communication apparatuses 111A, 111B, 111C, and the like are represented as STA1, STA2, STA3, and the like respectively.

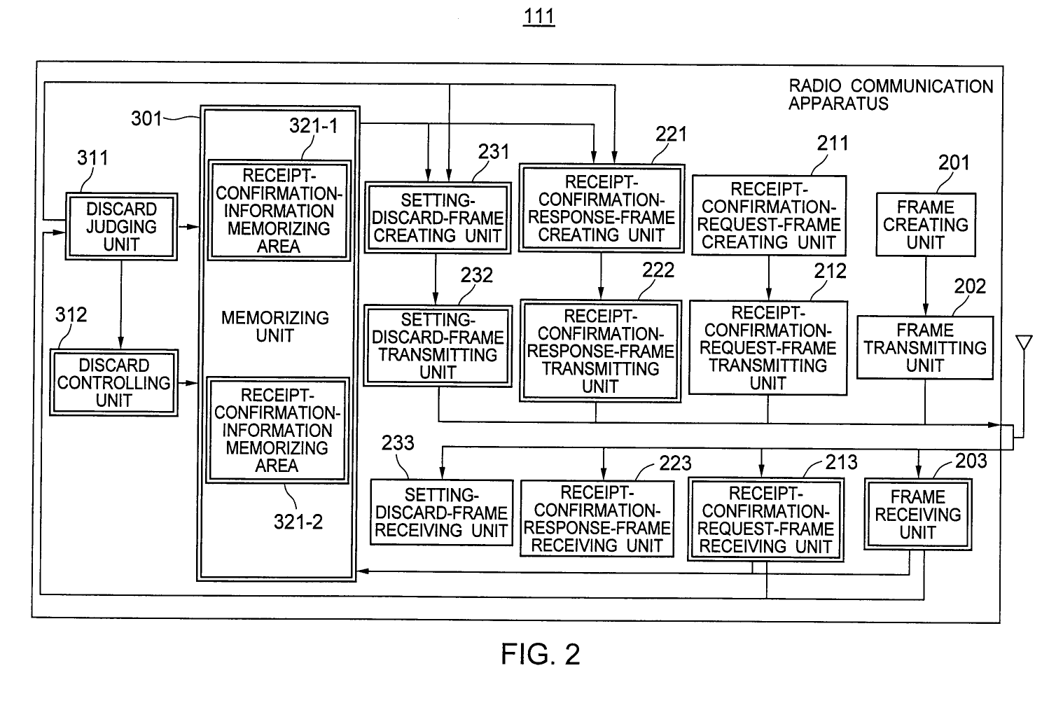

FIG. 2 is a functional block diagram of a radio communication apparatus 111 in FIG. 1. The radio communication apparatus 111 includes a frame creating unit 201, a frame transmitting unit 202, a frame receiving unit 203, a memorizing unit 301, a receipt-confirmation-request-frame creating unit 211, a receipt-confirmation-request-frame transmitting unit 212, a receipt-confirmation-request-frame receiving unit 213, a receipt-confirmation-response-frame creating unit 221, a receipt-confirmation-response-frame transmitting unit 222, a receipt-confirmation-response-frame receiving unit 223, a discard judging unit 311, a discard controlling unit 312, a setting-discard-frame creating unit 231, a setting-discard-frame transmitting unit 232, and a setting-discard-frame receiving unit 233. Functional blocks surrounded by single lines are functional blocks for frame transmission. Functional blocks surrounded by double lines are functional blocks for frame reception. The functional blocks for frame reception do not have to be provided in the radio communication apparatuses 111 specialized for frame transmission. The functional blocks for frame transmission do not have to be provided in the radio communication apparatuses 111 specialized for frame reception.

The frame creating unit 201 is a block that creates a frame (a frame sequence) including one or more data frames. An example of the data frame is a QoS data frame of IEEE802.11n. An example of the frame is an A-MPDU frame of IEEE802.11n. The frame transmitting unit 202 is a block that transmits a frame to another radio communication apparatus 111 via an antenna or the like. The frame receiving unit 203 is a block that receives a frame from another radio communication apparatus 111 via the antenna or the like.

The memorizing unit 301 is a block capable of memorizing receipt confirmation information, which is information for receipt confirmation of a frame. An example of the receipt confirmation information of a frame is a bitmap of IEEE802.11n. It is possible to secure two or more receipt confirmation information memorizing areas 321 in the memorizing unit 301. Each of the receipt confirmation information memorizing areas 321 is a memorizing area for memorizing the receipt confirmation information of a frame, and is a common memorizing area for memorizing receipt confirmation information of frames from the plural radio communication apparatuses 111. When the receipt confirmation information is a bitmap, the receipt confirmation information memorizing areas 321 are represented as bitmap memorizing areas 321 as appropriate. A receipt confirmation information memorizing area (a bitmap memorizing area) 321 is capable of containing a piece of receipt confirmation information (a bitmap). For example, the memorizing unit 301 may be realized by one semiconductor memory or may be realized by two or more semiconductor memories.

In this embodiment, it is assumed that it is possible to secure up to two receipt confirmation information memorizing areas 321 in the memorizing unit 301. In FIG. 2, a first receipt confirmation information memorizing area 321-1 and a second receipt confirmation information memorizing area 321-2 are shown as the two receipt confirmation information memorizing areas 321. Both of these receipt confirmation information memorizing areas 321 are common memorizing areas for memorizing receipt confirmation information of frames from the plural radio communication apparatuses 111. Therefore, for example, when the radio communication apparatus 111 in FIG. 2 is the STA1, it is possible to use both of these receipt confirmation information memorizing areas 321, as memorizing areas for receipt confirmation information of frames from the STA2, or as memorizing areas for receipt confirmation information of frames from the STA3.

The receipt-confirmation-request-frame creating unit 211 is a block that creates a receipt confirmation request frame for requesting receipt confirmation of a frame. An example of the receipt confirmation request frame is a block ack request frame of IEEE802.11n. The receipt-confirmation-request-frame transmitting unit 212 is a block that transmits a receipt confirmation request frame to another radio communication apparatus 111 via the antenna or the like. The receipt-confirmation-request-frame receiving unit 213 is a block that receives a receipt confirmation request frame from another radio communication apparatus 111 via the antenna or the like.

The receipt-confirmation-response-frame creating unit 221 is a block that creates a receipt confirmation response frame for responding to a receipt confirmation request frame, using the receipt confirmation information memorized in the memorizing unit 301. An example of the receipt confirmation response frame is a block ack frame of IEEE802.11n. The receipt-confirmation-response-frame transmitting unit 222 is a block that transmits a receipt confirmation response frame to another radio communication apparatus 111 via the antenna or the like. The receipt-confirmation-response-frame receiving unit 223 is a block that receives a receipt confirmation response frame from another radio communication apparatus 111 via the antenna or the like.

The discard judging unit 311 is a block that judges whether the receipt confirmation information memorized in the memorizing unit 301 is discarded, and selects a receipt confirmation information memorizing area 321 from which the receipt confirmation information is discarded. In this embodiment, the receipt confirmation information memorizing area 321-1 or the receipt confirmation information memorizing area 321-2 is selected by the discard judging unit 311. The discard judging unit 311 judges whether the receipt confirmation information memorized in the memorizing unit 301 is discarded or not. The discard judging unit 311 may select a receipt-confirmation-information memorizing area 321 from which the receipt confirmation information is discarded, after judging that the receipt confirmation information is discarded, or in advance before judging that the receipt confirmation information is discarded. The discard controlling unit 312 is a block that discards the receipt confirmation information from the receipt confirmation information memorizing area 321. In this embodiment, the receipt confirmation information is discarded from the receipt confirmation information memorizing area 321-1 or the receipt confirmation information memorizing area 321-2 by the discard controlling unit 312. The discard controlling unit 312 discards the receipt confirmation information from the selected receipt-confirmation-information memorizing area 321.

The setting-discard-frame creating unit 231 is a block that creates, triggered by the discard of the receipt confirmation information from the receipt confirmation information memorizing area 321, a setting discard frame for discarding a setting of selective retransmission. An example of the setting discard frame is a DELBA frame of IEEE802.11n. The setting-discard-frame transmitting unit 232 is a block that transmits a setting discard frame to another radio communication apparatus 111 via the antenna or the like. The setting-discard-frame receiving unit 233 is a block that receives a setting discard frame from another radio communication apparatus 111 via the antenna or the like. The radio communication apparatus 111 further includes a setting-frame creating unit that creates a setting frame for setting selective retransmission, a setting-frame transmitting unit that transmits a setting frame, and a setting-frame receiving unit that receives a setting frame. The setting of selective retransmission is set according to a setting frame, and is discarded according to a setting discard frame.

As described above, the radio communication apparatus 111 according to this embodiment includes the discard controlling unit 312, which discards receipt confirmation information from a receipt confirmation information memorizing area 321. Therefore, in this embodiment, it is possible to discard receipt confirmation information from a receipt confirmation information memorizing area 321, in order to deal with a case where the receipt confirmation information memorizing areas 321 are entirely filled with receipt confirmation information.

Moreover, the radio communication apparatus 111 according to this embodiment includes the discard judging unit 311, which judges whether receipt confirmation information memorized in the memorizing unit 301 is discarded, and selects a receipt confirmation information memorizing area 321 from which receipt confirmation information is discarded. Consequently, in this embodiment, depending on the judgment and the selection, it is possible to select, at appropriate timing, a receipt confirmation information memorizing area 321 from which receipt confirmation information is discarded, and to discard receipt confirmation information from an appropriate receipt confirmation information memorizing area 321. For example, it is possible to perform such a control as keeping receipt confirmation information whose discard leads to a relatively large loss and discarding receipt confirmation information whose discard leads to a relatively small loss. Specific examples of judgment processing and selection processing will be described below.

Each of the receipt confirmation information memorizing areas 321 according to this embodiment is a common memorizing area for memorizing receipt confirmation information of frames from the plural radio communication apparatuses 111. Therefore, in this embodiment, it is possible to cope with a large number of terminals and a large number of data types, using a small number of receipt confirmation information memorizing areas 321.

In the memorizing unit 301 according to this embodiment, it is possible to secure a pair or more of such common receipt-confirmation-information memorizing areas 321. Consequently, in this embodiment, when receipt confirmation information is to be discarded from a receipt-confirmation-information memorizing area 321, there is room, as described above, to select a receipt-confirmation-information memorizing area 321 from which receipt confirmation information is to be discarded. The maximum number of the receipt confirmation information memorizing areas 321 that can be secured in the memorizing unit 301, is desirably about two, three, or four. This is because, when the number of the receipt confirmation information memorizing areas 321 is too large, a search time for receipt confirmation information is wasted and required memorizing areas increase.

For example, as described later, the discard judging unit 311 acquires, concerning each of pieces of receipt confirmation information memorized in the memorizing unit 301, information about the receipt confirmation information or information about a frame corresponding to the receipt confirmation information. Then, the discard judging unit 311 selects, based on the acquired information, a receipt confirmation information memorizing area 321 from which receipt confirmation information is discarded. For example, as described later, the discard judging unit 311 acquires, concerning each of pieces of receipt confirmation information memorized in the memorizing unit 301 and receipt confirmation information of a newly received frame, information about the receipt confirmation information or information about a frame corresponding to the receipt confirmation information. Then, the discard judging unit 311 selects, based on the acquired information, a receipt confirmation information memorizing area 321 from which receipt confirmation information is discarded, or determines, based on the acquired information, to discard the receipt confirmation information of the newly received frame.

Examples of the information about the receipt confirmation information will be described in first and fourth specific examples described later. An example of the information about the receipt confirmation information is information about update of the receipt confirmation information. Examples of the information about a frame corresponding to the receipt confirmation information will be described in second, third, and fifth specific examples described later. An example of the information about a frame corresponding to the receipt confirmation information is information about reception or the type of the frame. Examples of methods of acquiring these kinds of information are such methods as the discard judging unit 311 calculates the information, the discard judging unit 311 receives the information from another block, and the radio communication apparatus 111 receives the information from another apparatus.

Various specific examples of the radio communication processing executed by the radio communication apparatus 111 will be hereinafter described. Each of the following specific examples is described, as an example, with regard to the radio communication processing conforming to IEEE802.11n.

### First Specific Example

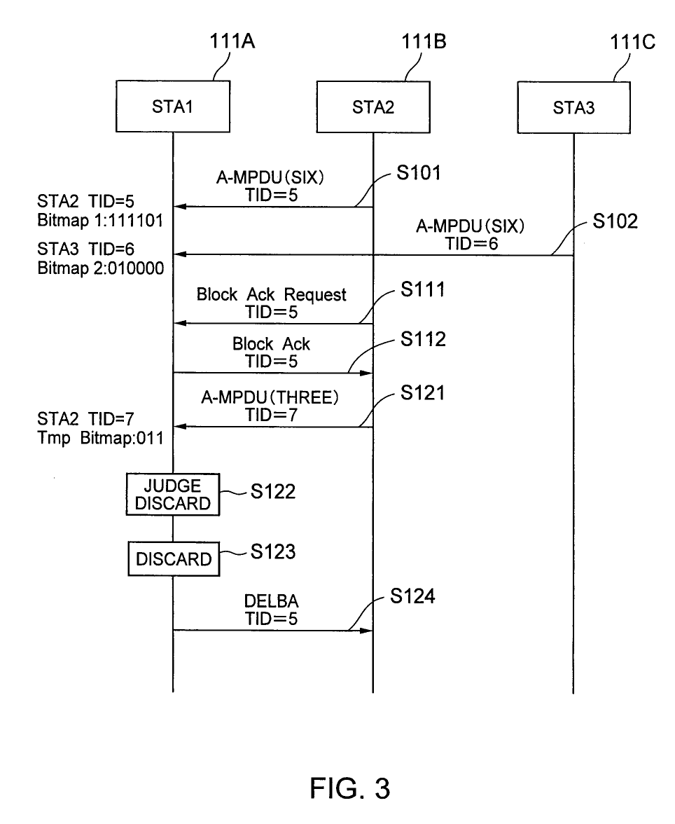

FIG. 3 is a sequence chart concerning a first specific example of the radio communication processing. In FIG. 3, the STA1 is a receiver of frame sequences, and the STA2 and the STA3 are transmitters of frame sequences.

First, an A-MPDU frame including six QoS data frames of TID=5 is created in the STA2 and transmitted from the STA2 to the STA1 (S101). The STA1 receives this A-MPDU frame via an antenna and analyzes the received A-MPDU frame. A result of the analysis is notified to the discard judging unit 311 of the STA1.

Next, the discard judging unit 311 judges that, among held bitmaps, there is no bitmap both of whose transmission source address and TID coincide with those of the A-MPDU frame. Subsequently, the discard judging unit 311 judges that there is a free memorizing area in the bitmap memorizing areas 321 of the STA1, and the frame receiving unit 203 of the STA1 memorizes a reception result “111101” in the bitmap memorizing area 321-1 (bitmap 1). The reception result indicates that the first, second, third, fourth, and sixth QoS data frames are correctly received, and the fifth QoS data frame is not correctly received. In the memorizing unit 301 of the STA1, the transmission source address (STA2) and the data type of the data frames (TID=5) are memorized as information incidental to a bitmap in the bitmap 1.

Next, an A-MPDU frame including six QoS data frames of TID=6 is created in the STA3 and transmitted from the STA3 to the STA1 (S102). The STA1 receives this A-MPDU frame via an antenna and analyzes the received A-MPDU frame. A result of the analysis is notified to the discard judging unit 311 of the STA1.

Next, the discard judging unit 311 judges that, among held bitmaps, there is no bitmap both of whose transmission source address and TID coincide with those of the A-MPDU frame. Subsequently, the discard judging unit 311 judges that there is a free memorizing area in the bitmap memorizing areas 321 of the STA1, and the frame receiving unit 203 of the STA1 memorizes a reception result “010000” in the bitmap memorizing area 321-2 (bitmap 2). The reception result indicates that the second QoS data frame is correctly received, and the first, third, fourth, fifth, and sixth QoS data frames are not correctly received. In the memorizing unit 301 of the STA1, the transmission source address (STA3) and the data type of the data frames (TID=6) are memorized as information incidental to a bitmap in the bitmap 2.

Next, a block ack request frame for requesting receipt confirmation of the A-MPDU frame of TID=5 is created in the STA2 and transmitted from the STA2 to the STA1 (S111). The STA1 receives this block ack request frame via an antenna and analyzes the received block ack request frame. A result of the analysis is notified to the discard judging unit 311 of the STA1.

Next, the discard judging unit 311 judges whether there is a bitmap both of whose transmission source address and TID coincide with those of the block ack request frame, among held bitmaps. Then, the discard judging unit 311 extracts a bitmap from the bitmap 1. The bitmap contains the reception result of the A-MPDU frame of TID=5: “111101”. The discard judging unit 311 notifies, triggered by the extraction of the bitmap from the bitmap 1, the bitmap and its transmission source address and TID to the receipt-confirmation-response-frame creating unit 221 of the STA1.

Next, a block ack frame for responding to the block ack request frame is created in the STA1 using the bitmap, and is transmitted from the STA1 to the STA2 after SIFS from completion of the reception of the block ack request (S112). The STA2 receives this block ack frame via an antenna and analyzes the received block ack frame.

After the transmission of the block ack frame, the receipt-confirmation-response-frame transmitting unit 222 of the STA1 notifies that the bitmap in the bitmap 1 is a bitmap which has not been updated from the reception of the A-MPDU frame to the present, to the discard judging unit 311 of the STA1. The receipt-confirmation-response-frame transmitting unit 222 may perform the notification to the discard judging unit 311, triggered by the transmission of the block ack frame; then the discard judging unit 311 may notify that the bitmap in the bitmap 1 is set as a bitmap which is to be discarded next, to the discard controlling unit 312 of the STA1, based on the trigger.

Next, an A-MPDU frame including three QoS data frames of TID=7 is created in the STA2 and transmitted from the STA2 to the STA1 (S121). The STA1 receives this A-MPDU frame via an antenna and analyzes the received A-MPDU frame. A result of the analysis is notified to the discard judging unit 311 of the STA1.

Next, the discard judging unit 311 judges that, among held bitmaps, there is no bitmap both of whose transmission source address and TID coincide with those of the A-MPDU frame. Subsequently, since there is no free memorizing area in the bitmap memorizing areas 321 of the STA1, the discard judging unit 311 judges that it is necessary to discard a held bitmap, and selects a bitmap memorizing area 321 from which a bitmap is discarded (S122). Here, the discard judging unit 311 selects a bitmap memorizing area 321 from which a bitmap is discarded, based on whether the bitmap has been updated or not. Here, since the bitmap in the bitmap 1 has not been updated from the reception of the A-MPDU frame to the present, the discard judging unit 311 instructs the discard controlling unit 312 of the STA1 to discard the bitmap in the bitmap 1. According to the instruction, the discard controlling unit 312 discards the bitmap in the bitmap 1 and its incidental information, from the memorizing unit 301 of the STA1 (S123).

Subsequently, the frame receiving unit 203 of the STA1 memorizes a reception result “011” of the A-MPDU frame of TID=7, in the bitmap 1. The reception result indicates that the second and third QoS data frames are correctly received, and the first QoS data frame is not correctly received. In the memorizing unit 301 of the STA1, the transmission source address (STA2) and the data type of the QoS data frames (TID=7) are memorized as information incidental to the bitmap in the bitmap 1.

Moreover, triggered by the discard of the bitmap from the bitmap 1, the discard judging unit 311 of the STA1 may instruct the setting-discard-frame creating unit 231 of the STA1 to create a DELBA frame for discarding a setting of selective retransmission of the A-MPDU frame of TID=5, and the setting-discard-frame creating unit 231 may create the DELBA frame (S124). In this case, the DELBA frame is transmitted from the STA1 to the STA2, after execution of carrier sense and back-off based on an EDCA scheme of IEEE802.11e. Then, the STA2 receives the DELBA frame via an antenna and analyzes the received DELBA frame. Consequently, the STA2 can recognize that the bitmap of the A-MPDU frame of TID=5 is discarded, without transmitting a block ack request frame. Therefore, useless generation of a block ack request frame is suppressed. The discarding of the setting of selective retransmission in S124 is performed on the premise that the setting of selective retransmission is performed before S101.

As described above, the radio communication apparatus 111 in the first specific example selects a bitmap memorizing area 321 from which a bitmap is discarded, based on whether update of the bitmap is performed. Here, a bitmap memorizing area 321 containing a bitmap which is not updated since the reception of the A-MPDU frame, is selected as a bitmap memorizing area 321 from which a bitmap is discarded.

It is highly likely that a bitmap not updated has already been received on the transmission side, so it is less necessary to hold the bitmap on the reception side. Therefore, by preferentially discarding a bitmap not updated, it is possible to preferentially keep a bitmap not received on the transmission side yet. In this way, in the first specific example, a limited number of bitmap memorizing areas 321 are efficiently used.

Furthermore, it is highly likely that a bitmap not updated has already been received on the transmission side, so it is less likely that its block ack request frame is sent from the transmission side. Therefore, by preferentially discarding a bitmap not updated, it is possible to reduce retransmissions of data frames. Consequently, in the first specific example, time during which a radio transmission path is occupied by retransmissions of data frames is reduced and throughput is improved.

In this embodiment, update of a bitmap is executed when an A-MPDU frame is received or a block ack request frame is received. In this embodiment, an instruction concerning update of a bitmap is issued from the frame receiving unit 203 or the receipt-confirmation-request-frame receiving unit 213 to the discard judging unit 311, and the update of the bitmap is executed by the discard judging unit 311.

Prioritization of the bitmap memorizing areas 321 will be hereinafter described.

The discard judging unit 311 may select a bitmap memorizing area 321 from which a bitmap is discarded, in a form of prioritizing the bitmap memorizing areas 321. In this case, the discard judging unit 311 may perform prioritization, triggered by discard of a bitmap from a bitmap memorizing area 321, reception of a receipt confirmation request frame, transmission of a receipt confirmation response frame, or elapse of a certain time, for discarding a bitmap from a certain bitmap memorizing area 321. In this case, the discard controlling unit 312 discards a bitmap from the certain bitmap memorizing area 321 in accordance with the prioritization.

For example, at the time of reception of a receipt confirmation request frame for the bitmap in the bitmap 1, or at the time of transmission of a receipt confirmation response frame for the bitmap in the bitmap 1, if the bitmap in the bitmap 1 is a bitmap not updated, the discard judging unit 311 may operate as follows. That is, the discard judging unit 311 may perform such prioritization, triggered by the reception of the receipt confirmation request frame or the transmission of the receipt confirmation response frame, as the bitmap in the bitmap 1 is to be discarded at the time of the next bitmap discard. In this case, the discard controlling unit 312 discards the bitmap in the bitmap 1 in accordance with the prioritization at the time of the next bitmap discard.

For example, the discard judging unit 311 may perform such prioritization, triggered by discard of the bitmap from the bitmap 1, as the bitmap in the bitmap 2 (which is a remaining bitmap) is to be discarded at the time of the next bitmap discard. In this case, the discard controlling unit 312 discards the bitmap in the bitmap 2 in accordance with the prioritization at the time of the next bitmap discard.

For example, the discard judging unit 311 may perform such prioritization, triggered by time-up of a timer for a fixed time, as a bitmap in a certain bitmap memorizing area is to be discarded at the time of the next bitmap discard. In this case, the discard controlling unit 312 discards the bitmap in the certain bitmap memorizing area in accordance with the prioritization at the time of the next bitmap discard.

As described above, various timings are conceivable as timings for prioritizing the bitmap memorizing areas 321. The prioritization triggered by reception of a receipt confirmation request frame or transmission of a receipt confirmation response frame has an advantage that, for example, when the prioritization is performed using a result of a bitmap search, it is possible to unify a bitmap search for creating a receipt confirmation response frame and a bitmap search for prioritization. The prioritization triggered by discard of a bitmap from a bitmap memorizing area 321 has an advantage that, for example, new prioritization is carried out when a bitmap is discarded, that is, when new prioritization is desired to be set. The prioritization triggered by elapse of a certain time has an advantage that, for example, the prioritization is updated periodically.

In the prioritization of the bitmap memorizing areas 321, orders of priority may be given to each of the bitmap memorizing areas 321, or only a bitmap memorizing area 321 which is to be discarded next may be specified. The prioritization of the bitmap memorizing areas 321 in the first specific example is also applicable to other specific examples described later.

Examples of data structures of a block ack request frame, a block ack frame, a QoS data frame, and an A-MPDU frame will be hereinafter described.

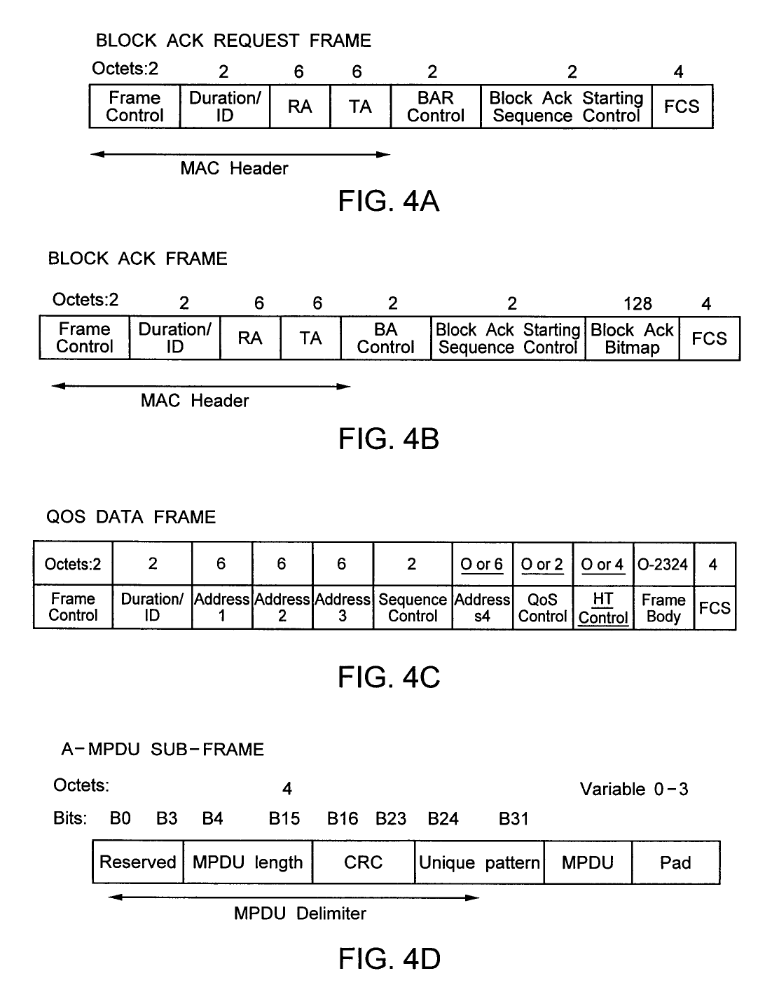

FIG. 4A represents an example of a frame structure of a block ack request frame. The block ack request frame in FIG. 4A includes a Frame Control field, a Duration/ID field, an RA field, a TA field, a BAR Control field, a Block Ack Starting Sequence Control field, an FCS field, and the like.

In the Frame Control field, data indicating that the frame is a block ack request frame is set. In the Duration/ID field, time during which a radio band is desired to be occupied after the frame is set. In the RA field, an address of a destination of the frame is set. In the TA field, an address of a transmission source of the frame is set. In the BAR control field, a TID (data type) and the like of an A-MPDU frame for which receipt confirmation is requested is set. In the Block Ack Starting Sequence Control field, it is set, for example, from which number of data the receipt confirmation is desired. In the FCS field, data for error inspection of the frame is set.

FIG. 4B represents an example of a frame structure of a block ack frame. The block ack frame in FIG. 4B includes a Frame Control field, a Duration/ID field, an RA field, a TA field, a BA Control field, a Block Ack Starting Sequence Control field, a Block Ack Bitmap field, an FCS field, and the like.

In the Frame Control field, data indicating that the frame is a block ack frame is set. In the Duration/ID field, time during which a radio band is desired to be occupied after the frame is set. In the RA field, an address of a destination of the frame is set. In the TA field, an address of a transmission source of the frame is set. In the BA Control field, a TID (data type) and the like of an A-MPDU frame for which receipt confirmation was requested is set. In the Block Ack Starting Sequence Control field, it is set, for example, from which number of data the receipt confirmation was obtained. In the Block Ack Bitmap field, a bitmap of an A-MPDU frame for which the receipt confirmation was requested is set. In the FCS field, data for error inspection of the frame is set.

FIG. 4C represents an example of a frame structure of a QoS data frame. The QoS data frame in FIG. 4C includes a Frame Control field, a Duration/ID field, an Address field, a Sequence Control field, a QoS Control field, an HT Control field, a Frame Body field, an FCS field, and the like.

In the Frame Control field, data indicating that the frame is a QoS data frame is set. In the Duration/ID field, time during which a radio band is desired to be occupied after the frame is set. In the Address field, an address of a destination of the frame and an address of a transmission source of the frame are set. In the Sequence Control field, a data number and the like is set. In the QoS Control field, a TID (data type) and the like is set. In the Frame Body field, contents of data frame are set. In the FCS field, data for error inspection of the frame is set.

FIG. 4D represents an example of a frame structure of an A-MPDU sub-frame. An A-MPDU frame includes one or more A-MPDU sub-frames. In the A-MPDU sub-frame in FIG. 4D, an MPDU Delimiter and a Padding are added to the front and the end of an MPDU respectively. An MPDU contains a QoS data frame. The MPDU Delimiter includes an MPDU length field, a CRC field, a Unique pattern field, and the like.

In the MPDU length field, the length of the MPDU is set. In the CRC field, data for error inspection of the frame is set. In the Unique pattern field, “0x4e” indicating “N” in the ASCII code is set.

The Padding at the end of the A-MPDU sub-frame is data added to set the length of the A-MPDU sub-frame integer times as large as 4 Octets. The Padding is not added to the A-MPDU sub-frame at the end of the A-MPDU frame.

### Second Specific Example

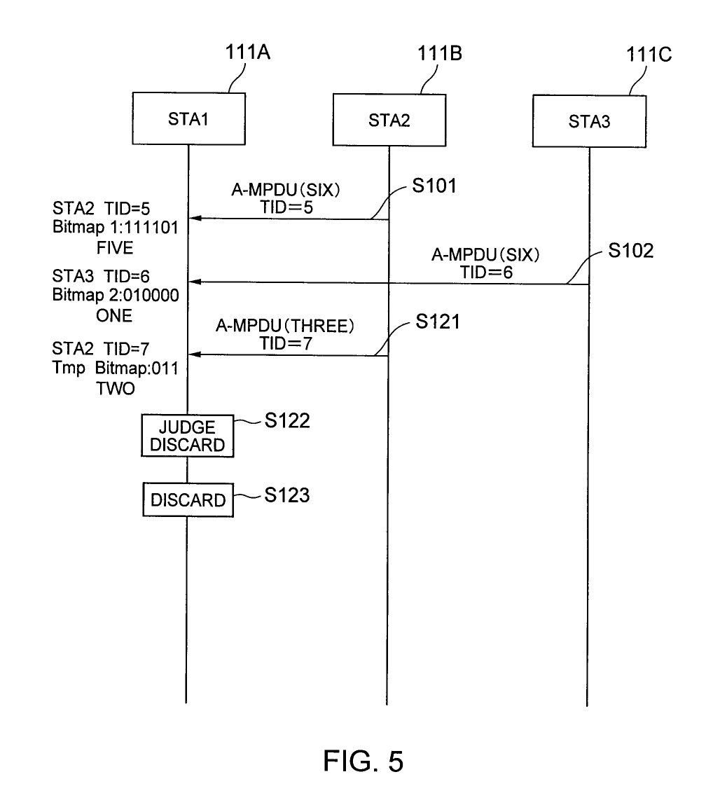

FIG. 5 is a sequence chart concerning a second specific example of the radio communication processing. In FIG. 5, the STA1 is a receiver of frame sequences, and the STA2 and the STA3 are transmitters of frame sequences. The second specific example is a modification of the first specific example. Concerning the second specific example, differences from the first specific example will be mainly described.

First, an A-MPDU frame including six QoS data frames of TID=5 is created in the STA2 and transmitted from the STA2 to the STA1 (S101). The STA1 receives this A-MPDU frame via an antenna and analyzes the received A-MPDU frame. A result of the analysis is notified to the discard judging unit 311 of the STA1.

Next, the discard judging unit 311 judges that, among held bitmaps, there is no bitmap both of whose transmission source address and TID coincide with those of the A-MPDU frame. Subsequently, the discard judging unit 311 judges that there is a free memorizing area in the bitmap memorizing areas 321 of the STA1, and memorizes a reception result “111101” in the bitmap memorizing area 321-1 (bitmap 1). In the memorizing unit 301 of the STA1, the transmission source address (STA2) and the data type of the data frames (TID=5) are memorized as information incidental to a bitmap in the bitmap 1.

Next, an A-MPDU frame including six QoS data frames of TID=6 is created in the STA3 and transmitted from the STA3 to the STA1 (S102). The STA1 receives this A-MPDU frame via an antenna and analyzes the received A-MPDU frame. A result of the analysis is notified to the discard judging unit 311 of the STA1.

Next, the discard judging unit 311 judges that, among held bitmaps, there is no bitmap both of whose transmission source address and TID coincide with those of the A-MPDU frame. Subsequently, the discard judging unit 311 judges that there is a free memorizing area in the bitmap memorizing areas 321 of the STA1, and memorizes a reception result “010000” in the bitmap memorizing area 321-2 (bitmap 2). In the memorizing unit 301 of the STA1, the transmission source address (STA3) and the data type of the data frames (TID=6) are memorized as information incidental to a bitmap in the bitmap 2.

Next, an A-MPDU frame including three QoS data frames of TID=7 is created in the STA2 and transmitted from the STA2 to the STA1 (S121). The STA1 receives this A-MPDU frame via an antenna and analyzes the received A-MPDU frame. A result of the analysis is notified to the discard judging unit 311 of the STA1.

Next, the discard judging unit 311 judges that, among held bitmaps, there is no bitmap both of whose transmission source address and TID coincide with those of the A-MPDU frame. Subsequently, since there is no free memorizing area in the bitmap memorizing areas 321 of the STA1, the discard judging unit 311 judges that it is necessary to discard a held bitmap, and selects a bitmap memorizing area 321 from which a bitmap is discarded (S122). Specific details of S122 will be described below. A reception result “011” of the A-MPDU frame of TID=7 is temporarily held by the discard judging unit 311 until S123 as a provisional bitmap, together with the transmission source address (STA2) and the data type of the QoS data frames (TID=7). The provisional bitmap is a bitmap for holding temporarily.

<2-1>

In S122, for example, the discard judging unit 311 acquires, concerning each of bitmaps memorized in the memorizing unit 301, the number of QoS data frames correctly received. Then, the discard judging unit 311 selects, based on the number, a bitmap memorizing area 321 from which a bitmap is discarded. Here, the discard judging unit 311 calculates the number; however, the frame receiving unit 203 may calculate the number and notify a result of the calculation to the discard judging unit 311.

For example, it is assumed that a reception result “111101” of an A-MPDU frame is contained in a bitmap in the bitmap 1, and a reception result “010000” of an A-MPDU frame is contained in a bitmap in the bitmap 2. In this case, the number of correctly received QoS data frames in the bitmap in the bitmap 1 is five, and the number of correctly received QoS data frames in the bitmap in the bitmap 2 is one. Therefore, the discard judging unit 311 here instructs the discard controlling unit 312 of the STA1, to discard the bitmap in the bitmap 2 having the smallest number of correctly received QoS data frames. According to the instruction, the discard controlling unit 312 discards the bitmap in the bitmap 2 and its incidental information, from the memorizing unit 301 of the STA1 (S123).

Subsequently, the discard judging unit 311 memorizes the reception result “011” of the A-MPDU frame of TID=7 in the bitmap 2. In the memorizing unit 301 of the STA1, the transmission source address (STA2) and the data type of the QoS data frames (TID=7) are memorized as information incidental to the bitmap in the bitmap 2.

As described above, the radio communication apparatus 101 in this example acquires, concerning each of bitmaps memorized in the memorizing unit 301, the number of correctly received QoS data frames and selects, based on the number, a bitmap memorizing area 321 from which a bitmap is discarded. Here, a bitmap memorizing area 321 containing a bitmap having the smallest number of correctly received QoS data frames, is selected as a bitmap memorizing area 321 from which a bitmap is discarded.

If a bitmap is discarded, all QoS data frames for the bitmap are retransmitted in receipt confirmation. Therefore, if a bitmap having a large number of correctly received QoS data frames is discarded, a large number of correctly received QoS data frames are retransmitted regardless of the fact that these QoS data frames are correctly received, so that a large number of correctly received QoS data frames are wasted. However, if a bitmap having a small number of correctly received QoS data frames is discarded, a small number of correctly received QoS data frames are retransmitted regardless of the fact that these QoS data frames are correctly received, so that a small number of correctly received QoS data frames are wasted. Therefore, by preferentially discarding a bitmap having a small number of correctly received QoS data frames, it is possible to preferentially keep a bitmap that results in a waste of a large number of correctly received QoS data frames if discarded. In this way, in this example, a limited number of bitmap memorizing areas 321 are efficiently used.

In general, when the number of correctly received QoS data frames is large, the number of QoS data frames required to be retransmitted is small. Therefore, by preferentially keeping a bitmap having a large number of correctly received QoS data frames, it is possible to reduce retransmissions of data frames. Consequently, in this example, time during which a radio transmission path is occupied by retransmissions of data frames is reduced and throughput is improved.

The discard judging unit 311 may perform prioritization, triggered by discard of a bitmap from a bitmap memorizing area 321, for discarding a bitmap from a certain bitmap memorizing area 321. For example, in this example, immediately after the bitmap is discarded from the bitmap 2, the number of correctly received QoS data frames in the bitmap in the bitmap 1 is five, and the number of correctly received QoS data frames in the new bitmap in the bitmap 2 is two. Therefore, such prioritization is performed as the new bitmap in the bitmap 2 having the smallest number of correctly received QoS data frames is to be discarded next.

<2-2>

In S122, for example, the discard judging unit 311 may acquire, concerning each of bitmaps memorized in the memorizing unit 301 and a bitmap (provisional bitmap) of a newly received A-MPDU frame, the number of QoS data frames correctly received. Then, the discard judging unit 311 may select, based on the number, a bitmap memorizing area 321 from which a bitmap is discarded, or may determine, based on the number, to discard the bitmap (provisional bitmap) of the newly received A-MPDU frame. In other words, a bitmap to be discarded may be selected out of bitmaps including a provisional bitmap.

For example, it is assumed that a reception result “111101” of an A-MPDU frame is contained in a bitmap in the bitmap 1, a reception result “010000” of an A-MPDU frame is contained in a bitmap in the bitmap 2, and a reception result “011” of an A-MPDU frame is contained in a provisional bitmap. In this case, the number of correctly received QoS data frames in the bitmap in the bitmap 1 is five, the number of correctly received QoS data frames in the bitmap in the bitmap 2 is one, and the number of correctly received QoS data frames in the provisional bitmap is two. Therefore, the discard judging unit 311 here instructs the discard controlling unit 312 of the STA1, to discard the bitmap in the bitmap 2 having the smallest number of correctly received QoS data frames. According to the instruction, the discard controlling unit 312 discards the bitmap in the bitmap 2 and its incidental information, from the memorizing unit 301 of the STA1 (S123).

Subsequently, the discard judging unit 311 memorizes the reception result “011” of the A-MPDU frame of TID=7 in the bitmap 2. In the memorizing unit 301 of the STA1, the transmission source address (STA2) and the data type of the QoS data frames (TID=7) are memorized as information incidental to the bitmap in the bitmap 2.

As described above, the radio communication apparatus 101 in this example acquires, concerning each of bitmaps memorized in the memorizing unit 301 and a bitmap of a newly received A-MPDU frame, the number of correctly received QoS data frames, and selects, based on the number, a bitmap memorizing area 321 from which a bitmap is discarded, or determines, based on the number, to discard the bitmap of the newly received A-MPDU frame. Therefore, in the processing in 2-2, the processing same as that in 2-1 is executed on bitmaps including a provisional bitmap.

In this example, a bitmap having the smallest number of correctly received QoS data frames is selected as a bitmap to be discarded. This is particularly effective in treating a provisional bitmap having a small number of correctly received QoS data frames.

### Third Specific Example

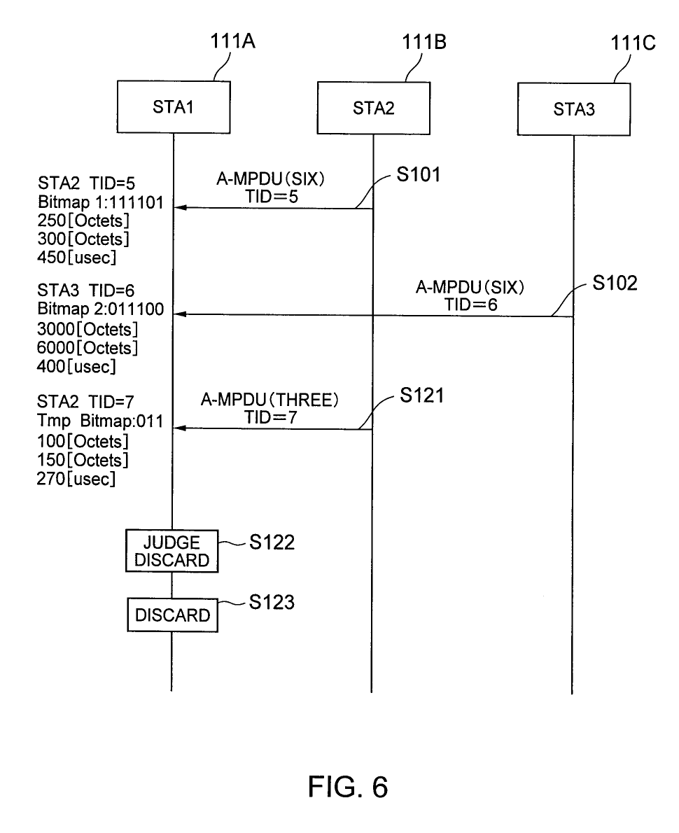

FIG. 6 is a sequence chart concerning a third specific example of the radio communication processing. In FIG. 6, the STA1 is a receiver of frame sequences, and the STA2 and the STA3 are transmitters of frame sequences. The third specific example is a modification of the first specific example. Concerning the third specific example, differences from the first specific example will be mainly described.

First, an A-MPDU frame including six QoS data frames of TID=5 is created in the STA2 and transmitted from the STA2 to the STA1 (S101). It is assumed that the frame length of each QoS data frame of the A-MPDU frame is 50 Octets. The STA1 receives this A-MPDU frame via an antenna and analyzes the received A-MPDU frame. A result of the analysis is notified to the discard judging unit 311 of the STA1.

Next, the discard judging unit 311 judges that, among held bitmaps, there is no bitmap both of whose transmission source address and TID coincide with those of the A-MPDU frame. Subsequently, the discard judging unit 311 judges that there is a free memorizing area in the bitmap memorizing areas 321 of the STA1, and memorizes a reception result “111101” in the bitmap memorizing area 321-1 (bitmap 1). In the memorizing unit 301 of the STA1, the transmission source address (STA2), the data type of the data frames (TID=5), the total length of correctly received QoS data frames (250 Octets), the total length of all the received QoS data frames (300 Octets), and the total reception time of all the received QoS data frames (450 μsec) are memorized as information incidental to a bitmap in the bitmap 1. The total lengths and the total reception time may be a result calculated by the frame receiving unit 203 after analyzing the frame and notified to the discard judging unit 311 by the frame receiving unit 203, or may be a result calculated by the discard judging unit 311 itself.

Next, an A-MPDU frame including six QoS data frames of TID=6 is created in the STA3 and transmitted from the STA3 to the STA1 (S102). It is assumed that the frame length of each QoS data frame of the A-MPDU frame is 1000 Octets. The STA1 receives this A-MPDU frame via an antenna and analyzes the received A-MPDU frame. A result of the analysis is notified to the discard judging unit 311 of the STA1.

Next, the discard judging unit 311 judges that, among held bitmaps, there is no bitmap both of whose transmission source address and TID coincide with those of the A-MPDU frame. Subsequently, the discard judging unit 311 judges that there is a free memorizing area in the bitmap memorizing areas 321 of the STA1, and memorizes a reception result “011100” in the bitmap memorizing area 321-2 (bitmap 2). In the memorizing unit 301 of the STA1, the transmission source address (STA3), the data type of the data frames (TID=6), the total length of correctly received QoS data frames (3000 Octets), the total length of all the received QoS data frames (6000 Octets), and the total reception time of all the received QoS data frames (400 μsec) are memorized as information incidental to a bitmap in the bitmap 2. The total lengths and the total reception time may be a result calculated by the frame receiving unit 203 after analyzing the frame and notified to the discard judging unit 311 by the frame receiving unit 203, or may be a result calculated by the discard judging unit 311 itself.

Next, an A-MPDU frame including three QoS data frames of TID=7 is created in the STA2 and transmitted from the STA2 to the STA1 (S121). It is assumed that the frame length of each QoS data frame of the A-MPDU frame is 50 Octets. The STA1 receives this A-MPDU frame via an antenna and analyzes the received A-MPDU frame. A result of the analysis is notified to the discard judging unit 311 of the STA1.

Next, the discard judging unit 311 judges that, among held bitmaps, there is no bitmap both of whose transmission source address and TID coincide with those of the A-MPDU frame. Subsequently, since there is no free memorizing area in the bitmap memorizing areas 321 of the STA1, the discard judging unit 311 judges that it is necessary to discard a held bitmap, and selects a bitmap memorizing area 321 from which a bitmap is discarded (S122). Specific details of S122 will be described below. A reception result “011” of the A-MPDU frame of TID=7 is temporarily held by the discard judging unit 311 until S123 as a provisional bitmap, together with the transmission source address (STA2), the data type of the QoS data frames (TID=7), the total length of correctly received QoS data frames (100 Octets), the total length of all the received QoS data frames (150 Octets), and the total reception time of all the received QoS data frames (270 μsec). The total lengths and the total reception time may be a result calculated by the frame receiving unit 203 after analyzing the frame and notified to the discard judging unit 311 by the frame receiving unit 203, or may be a result calculated by the discard judging unit 311 itself.

<3-1>

In S122, for example, the discard judging unit 311 acquires, concerning each of bitmaps memorized in the memorizing unit 301, the total length of QoS data frames correctly received. Then, the discard judging unit 311 selects, based on the total length, a bitmap memorizing area 321 from which a bitmap is discarded. Here, the discard judging unit 311 acquires, as the total length, the total length memorized in the memorizing unit 301 as information incidental to each bitmap.

The total length of correctly received QoS data frames in the bitmap in the bitmap 1 is 250 Octets, and the total length of correctly received QoS data frames in the bitmap in the bitmap 2 is 3000 Octets. Therefore, the discard judging unit 311 here instructs the discard controlling unit 312 of the STA1, to discard the bitmap in the bitmap 1 having the shortest total length of correctly received QoS data frames. According to the instruction, the discard controlling unit 312 discards the bitmap in the bitmap 1 and its incidental information, from the memorizing unit 301 of the STA1 (S123).

Subsequently, the discard judging unit 311 memorizes the reception result “011” of the A-MPDU frame of TID=7 in the bitmap 1. In the memorizing unit 301 of the STA1, the transmission source address (STA2), the data type of the QoS data frames (TID=7), the total length of the correctly received QoS data frames (100 Octets), the total length of all the received QoS data frames (150 Octets), and the total reception time of all the received QoS data frames (270 μsec) are memorized as information incidental to the bitmap in the bitmap 1.

As described above, the radio communication apparatus 101 in this example acquires, concerning each of bitmaps memorized in the memorizing unit 301, the total length of correctly received QoS data frames and selects, based on the total length, a bitmap memorizing area 321 from which a bitmap is discarded. Here, a bitmap memorizing area 321 containing a bitmap having the shortest total length of correctly received QoS data frames, is selected as a bitmap memorizing area 321 from which a bitmap is discarded.

Advantages of the processing in 3-1 are the same as those of the processing in 2-1. However, a fact that should be taken into account is that, even if the number of correctly received QoS data frames is small, if the total length of correctly received QoS data frames is large, “wastes” and “burdens of retransmissions of data frames” involved in discard of a bitmap are large. According to this example, effective discard of a bitmap with taking the total length of correctly received QoS data frames into account is realized.

<3-2>

In S122, for example, the discard judging unit 311 may acquire, concerning each of bitmaps memorized in the memorizing unit 301 and a bitmap (provisional bitmap) of a newly received A-MPDU frame, the total length of QoS data frames correctly received. Then, the discard judging unit 311 may select, based on the total length, a bitmap memorizing area 321 from which a bitmap is discarded, or may determine, based on the total length, to discard the bitmap (provisional bitmap) of the newly received A-MPDU frame. In other words, a bitmap to be discarded may be selected out of bitmaps including a provisional bitmap.

The total length of correctly received QoS data frames in the bitmap in the bitmap 1 is 250 Octets, the total length of correctly received QoS data frames in the bitmap in the bitmap 2 is 3000 Octets, and the total length of correctly received QoS data frames in the provisional bitmap is 100 Octets. Therefore, the discard judging unit 311 here determines to discard the provisional bitmap having the shortest total length of correctly received QoS data frames, and discards the held provisional bitmap and its incidental information (S123).

As described above, the radio communication apparatus 101 in this example acquires, concerning each of bitmaps memorized in the memorizing unit 301 and a bitmap of a newly received A-MPDU frame, the total length of correctly received QoS data frames, and selects, based on the total length, a bitmap memorizing area 321 from which a bitmap is discarded, or determines, based on the total length, to discard the bitmap of the newly received A-MPDU frame. Therefore, in the processing in 3-2, the processing same as that in 3-1 is executed on bitmaps including a provisional bitmap.

In this example, a bitmap having the shortest total length of correctly received QoS data frames is selected as a bitmap to be discarded. This is particularly effective in treating a provisional bitmap having a short total length of correctly received QoS data frames.

<3-3>

In S122, for example, the discard judging unit 311 may acquire, concerning each of bitmaps memorized in the memorizing unit 301, the total length of all the received QoS data frames. Then, the discard judging unit 311 may select, based on the total length, a bitmap memorizing area 321 from which a bitmap is discarded. Here, the discard judging unit 311 acquires, as the total length, the total length memorized in the memorizing unit 301 as information incidental to each bitmap.

The total length of all the received QoS data frames in the bitmap in the bitmap 1 is 300 Octets, and the total length of all the received QoS data frames in the bitmap in the bitmap 2 is 6000 Octets. Therefore, the discard judging unit 311 here instructs the discard controlling unit 312 of the STA1, to discard the bitmap in the bitmap 1 having the shortest total length of all the received QoS data frames. According to the instruction, the discard controlling unit 312 discards the bitmap in the bitmap 1 and its incidental information, from the memorizing unit 301 of the STA1 (S123).

Subsequently, the discard judging unit 311 memorizes the reception result “011” of the A-MPDU frame of TID=7 in the bitmap 1. In the memorizing unit 301 of the STA1, the transmission source address (STA2), the data type of the QoS data frames (TID=7), the total length of the correctly received QoS data frames (100 Octets), the total length of all the received QoS data frames (150 Octets), and the total reception time of all the received QoS data frames (270 μsec) are memorized as information incidental to the bitmap in the bitmap 1.

As described above, the radio communication apparatus 101 in this example acquires, concerning each of bitmaps memorized in the memorizing unit 301, the total length of received QoS data frames and selects, based on the total length, a bitmap memorizing area 321 from which a bitmap is discarded. Here, a bitmap memorizing area 321 containing a bitmap having the shortest total length of received QoS data frames, is selected as a bitmap memorizing area 321 from which a bitmap is discarded.

Advantages of the processing in 3-3 are the same as those of the processing in 3-1. However, what should be taken into account here is that what decides burdens of retransmissions of data frames is the total length of all the received QoS data frames rather than the total length of correctly received QoS data frames. According to this example, it is possible to more effectively reduce retransmissions of data frames, by preferentially discarding a bitmap having a short total length of all the received QoS data frames.

The discard judging unit 311 may select, based on the number of all the received QoS data frames instead of the total length of all the received QoS data frames, a bitmap memorizing area 321 from which a bitmap is discarded. In other words, the processing in 3-3 may be diverted to the second specific example, by replacing the total length of received QoS data frames with the number of received QoS data frames.

<3-4>

In S122, for example, the discard judging unit 311 may acquire, concerning each of bitmaps memorized in the memorizing unit 301 and a bitmap (provisional bitmap) of a newly received A-MPDU frame, the total length of all the received QoS data frames. Then, the discard judging unit 311 may select, based on the total length, a bitmap memorizing area 312 from which a bitmap is discarded, or may determine, based on the total length, to discard the bitmap (provisional bitmap) of the newly received A-MPDU frame. In other words, a bitmap to be discarded may be selected out of bitmaps including a provisional bitmap.

The total length of all the received QoS data frames in the bitmap in the bitmap 1 is 300 Octets, the total length of all the received QoS data frames in the bitmap in the bitmap 2 is 6000 Octets, and the total length of all the received QoS data frames in the provisional bitmap is 150 Octets. Therefore, the discard judging unit 311 here determines to discard the provisional bitmap having the shortest total length of all the received QoS data frames, and discards the held provisional bitmap and its incidental information (S123).

As described above, the radio communication apparatus 101 in this example acquires, concerning each of bitmaps memorized in the memorizing unit 301 and a bitmap of a newly received A-MPDU frame, the total length of received QoS data frames, and selects, based on the total length, a bitmap memorizing area 321 from which a bitmap is discarded, or determines, based on the total length, to discard the bitmap of the newly received A-MPDU frame. Therefore, in the processing in 3-4, the processing same as that in 3-3 is executed on bitmaps including a provisional bitmap.

In this example, a bitmap having the shortest total length of received QoS data frames is selected as a bitmap to be discarded. This is particularly effective in treating a provisional bitmap having a short total length of received QoS data frames.

The discard judging unit 311 may select, based on the number of all the received QoS data frames instead of the total length of all the received QoS data frames, a bitmap memorizing area 321 from which a bitmap is discarded, or may determine, based on the number of all the received QoS data frames instead of the total length of all the received QoS data frames, to discard a bitmap of a newly received A-MPDU frame. In other words, the processing in 3-4 may be diverted to the second specific example, by replacing the total length of received QoS data frames with the number of received QoS data frames.

<3-5>

In S122, for example, the discard judging unit 311 may acquire, concerning each of bitmaps memorized in the memorizing unit 301, the ratio of the total length of correctly received QoS data frames to the total length of all the received QoS data frames. Then, the discard judging unit 311 may select, based on the ratio, a bitmap memorizing area 321 from which a bitmap is discarded. Here, the discard judging unit 311 calculates the ratio, based on the total lengths memorized in the memorizing unit 301 as information incidental to each bitmap.

The ratio in the bitmap in the bitmap 1 is 0.83 (250 Octets/300 Octets), and the ratio in the bitmap in the bitmap 2 is 0.50 (3000 Octets/6000 Octets). Therefore, the discard judging unit 311 here instructs the discard controlling unit 312 of the STA1, to discard the bitmap in the bitmap 2 having the smallest ratio. According to the instruction, the discard controlling unit 312 discards the bitmap in the bitmap 2 and its incidental information, from the memorizing unit 301 of the STA1 (S123).

Subsequently, the discard judging unit 311 memorizes the reception result “011” of the A-MPDU frame of TID=7 in the bitmap 2. In the memorizing unit 301 of the STA1, the transmission source address (STA2), the data type of the QoS data frames (TID=7), the total length of the correctly received QoS data frames (100 Octets), the total length of all the received QoS data frames (150 Octets), and the total reception time of all the received QoS data frames (270 μsec) are memorized as information incidental to the bitmap in the bitmap 2.

As described above, the radio communication apparatus 101 in this example acquires, concerning each of bitmaps memorized in the memorizing unit 301, the ratio of the total length of correctly received QoS data frames to the total length of received QoS data frames and selects, based on the ratio, a bitmap memorizing area 321 from which a bitmap is discarded. Here, a bitmap memorizing area 321 containing a bitmap having the smallest ratio, is selected as a bitmap memorizing area 321 from which a bitmap is discarded.

Advantages of the processing in 3-5 are the same as those of the processing in 3-1. However, what should be taken into account here is that, even if the total length of correctly received QoS data frames is short, if the ratio of the total length of correctly received QoS data frames to the total length of all the received QoS data frames is large, “wastes” involved in discard of a bitmap are large. This is because the bitmap is discarded regardless of the fact that the percentage of the correctly received QoS data frames is large. According to this example, effective discard of a bitmap with taking the ratio into account is realized.

The discard judging unit 311 may select, based on the ratio of the number of correctly received QoS data frames to the number of all the received QoS data frames, instead of the ratio of the total length of correctly received QoS data frames to the total length of all the received QoS data frames, a bitmap memorizing area 321 from which a bitmap is discarded. In other words, the processing in 3-5 may be diverted to the second specific example, by replacing the ratio of the total length of correctly received QoS data frames to the total length of received QoS data frames, with the ratio of the number of correctly received QoS data frames to the number of received QoS data frames.

<3-6>

In S122, for example, the discard judging unit 311 may acquire, concerning each of bitmaps memorized in the memorizing unit 301 and a bitmap (provisional bitmap) of a newly received A-MPDU frame, the ratio of the total length of correctly received QoS data frames to the total length of all the received QoS data frames. Then, the discard judging unit 311 may select, based on the ratio, a bitmap memorizing area 321 from which a bitmap is discarded, or may determine, based on the ratio, to discard the bitmap (provisional bitmap) of the newly received A-MPDU frame. In other words, a bitmap to be discarded may be selected out of bitmaps including a provisional bitmap.

The ratio in the bitmap in the bitmap 1 is 0.83 (250 Octets/300 Octets), the ratio in the bitmap in the bitmap 2 is 0.50 (3000 Octets/6000 Octets), and the ratio in the provisional bitmap is 0.67 (100 Octets/150 Octets). Therefore, the discard judging unit 311 here instructs the discard controlling unit 312 of the STA1, to discard the bitmap in the bitmap 2 having the smallest ratio. According to the instruction, the discard controlling unit 312 discards the bitmap in the bitmap 2 and its incidental information, from the memorizing unit 301 of the STA1 (S123).

Subsequently, the discard judging unit 311 memorizes the reception result “011” of the A-MPDU frame of TID=7 in the bitmap 2. In the memorizing unit 301 of the STA1, the transmission source address (STA2), the data type of the QoS data frames (TID=7), the total length of the correctly received QoS data frames (100 Octets), the total length of all the received QoS data frames (150 Octets), and the total reception time of all the received QoS data frames (270 μsec) are memorized as information incidental to the bitmap in the bitmap 2.

As described above, the radio communication apparatus 101 in this example acquires, concerning each of bitmaps memorized in the memorizing unit 301 and a bitmap of a newly received A-MPDU frame, the ratio of the total length of correctly received QoS data frames to the total length of received QoS data frames, and selects, based on the ratio, a bitmap memorizing area 321 from which a bitmap is discarded, or determines, based on the ratio, to discard the bitmap of the newly received A-MPDU frame. Therefore, in the processing in 3-6, the processing same as that in 3-5 is executed on bitmaps including a provisional bitmap.

In this example, a bitmap having the smallest ratio is selected as a bitmap to be discarded. This is particularly effective in treating a provisional bitmap having the small ratio.

The discard judging unit 311 may select, based on the ratio of the number of correctly received QoS data frames to the number of all the received QoS data frames, instead of the ratio of the total length of correctly received QoS data frames to the total length of all the received QoS data frames, a bitmap memorizing area 321 from which a bitmap is discarded. The discard judging unit 311 may determine, based on the ratio of the number of correctly received QoS data frames to the number of all the received QoS data frames, instead of the ratio of the total length of correctly received QoS data frames to the total length of all the received QoS data frames, to discard a bitmap of a newly received A-MPDU frame. In other words, the processing in 3-6 may be diverted to the second specific example, by replacing the ratio of the total length of correctly received QoS data frames to the total length of received QoS data frames, with the ratio of the number of correctly received QoS data frames to the number of received QoS data frames.

<3-7>

In S122, for example, the discard judging unit 311 may acquire, concerning each of bitmaps memorized in the memorizing unit 301, the total reception time of correctly received QoS data frames. Then, the discard judging unit 311 may select, based on the total reception time, a bitmap memorizing area 321 from which a bitmap is discarded. Here, the discard judging unit 311 acquires, as the total reception time, the total reception time memorized in the memorizing unit 301 as information incidental to each bitmap.

The total reception time of correctly received QoS data frames in the bitmap in the bitmap 1 is 375 μsec (450 μsec*250 Octets/300 Octets), and the total reception time of correctly received QoS data frames in the bitmap in the bitmap 2 is 200 μsec (400 μsec*3000 Octets/6000 Octets). Therefore, the discard judging unit 311 here instructs the discard controlling unit 312 of the STA1, to discard the bitmap in the bitmap 2 having the shortest total reception time of correctly received QoS data frames. According to the instruction, the discard controlling unit 312 discards the bitmap in the bitmap 2 and its incidental information, from the memorizing unit 301 of the STA1 (S123).

Subsequently, the discard judging unit 311 memorizes the reception result “011” of the A-MPDU frame of TID=7 in the bitmap 2. In the memorizing unit 301 of the STA1, the transmission source address (STA2), the data type of the QoS data frames (TID=7), the total length of the correctly received QoS data frames (100 Octets), the total length of all the received QoS data frames (150 Octets), and the total reception time of all the received QoS data frames (270 μsec) are memorized as information incidental to the bitmap in the bitmap 2.

As described above, the radio communication apparatus 101 in this example acquires, concerning each of bitmaps memorized in the memorizing unit 301, the total reception time of correctly received QoS data frames and selects, based on the total reception time, a bitmap memorizing area 321 from which a bitmap is discarded. Here, a bitmap memorizing area 321 containing a bitmap having the shortest total reception time of correctly received QoS data frames, is selected as a bitmap memorizing area 321 from which a bitmap is discarded.

Advantages of the processing in 3-7 are the same as those of the processing in 3-1. Compared with the processing in 3-1, the processing in 3-7 is effective when greater importance is attached to the reception time of QoS data frames than the reception amount of QoS data frames.

The discard judging unit 311 may select, based on the total reception time of all the received QoS data frames, a bitmap memorizing area 321 from which a bitmap is discarded. In other words, in the processing in 3-7, the total reception time of correctly received QoS data frames may be replaced with the total reception time of received QoS data frames. Advantages of this processing are the same as those of the processing in 3-3.

The discard judging unit 311 may select, based on the ratio of the total reception time of correctly received QoS data frames to the total reception time of all the received QoS data frames, a bitmap memorizing area 321 from which a bitmap is discarded. In other words, in the processing in 3-7, the total reception time of correctly received QoS data frames may be replaced with the ratio of the total reception time of correctly received QoS data frames to the total reception time of received QoS data frames. Advantages of this processing are the same as those of the processing in 3-5.

<3-8>

In S122, for example, the discard judging unit 311 may acquire, concerning each of bitmaps memorized in the memorizing unit 301 and a bitmap (provisional bitmap) of a newly received A-MPDU frame, the total reception time of correctly received QoS data frames. Then, the discard judging unit 311 may select, based on the total reception time, a bitmap memorizing area 321 from which a bitmap is discarded, or may determine, based on the total reception time, to discard the bitmap (provisional bitmap) of the newly received A-MPDU frame. In other words, a bitmap to be discarded may be selected out of bitmaps including a provisional bitmap.

The total reception time of correctly received QoS data frames in the bitmap in the bitmap 1 is 375 μsec (450 μsec*250 Octets/300 Octets), the total reception time of correctly received QoS data frames in the bitmap in the bitmap 2 is 200 μsec (400 μsec*3000 Octets/6000 Octets), and the total reception time of correctly received QoS data frames in the provisional bitmap is 180 μsec (270 μsec*100 Octets/150 Octets). Therefore, the discard judging unit 311 here determines to discard the provisional bitmap having the shortest total reception time of correctly received QoS data frames, and discards the held provisional bitmap and its incidental information (S123).

As described above, the radio communication apparatus 101 in this example acquires, concerning each of bitmaps memorized in the memorizing unit 301 and a bitmap of a newly received A-MPDU frame, the total reception time of correctly received QoS data frames, and selects, based on the total reception time, a bitmap memorizing area 321 from which a bitmap is discarded, or determines, based on the total reception time, to discard the bitmap of the newly received A-MPDU frame. Therefore, in the processing in 3-8, the processing same as that in 3-7 is executed on bitmaps including a provisional bitmap.

In this example, a bitmap having the shortest total reception time of correctly received QoS data frames is selected as a bitmap to be discarded. This is particularly effective in treating a provisional bitmap having a short total reception time of correctly received QoS data frames.

The discard judging unit 311 may select, based on the total reception time of all the received QoS data frames, a bitmap memorizing area 321 from which a bitmap is discarded. The discard judging unit 311 may determine, based on the total reception time of all the received QoS data frames, to discard a bitmap of a newly received A-MPDU frame. In other words, in the processing in 3-8, the total reception time of correctly received QoS data frames may be replaced with the total reception time of received QoS data frames. Advantages of this processing are the same as those of the processing in 3-4.

The discard judging unit 311 may select, based on the ratio of the total reception time of correctly received QoS data frames to the total reception time of all the received QoS data frames, a bitmap memorizing area 321 from which a bitmap is discarded. The discard judging unit 311 may determine, based on the ratio of the total reception time of correctly received QoS data frames to the total reception time of all the received QoS data frames, to discard a bitmap of a newly received A-MPDU frame. In other words, in the processing in 3-8, the total reception time of correctly received QoS data frames may be replaced with the ratio of the total reception time of correctly received QoS data frames to the total reception time of received QoS data frames. Advantages of this processing are the same as those of the processing in 3-6.

### Fourth Specific Example

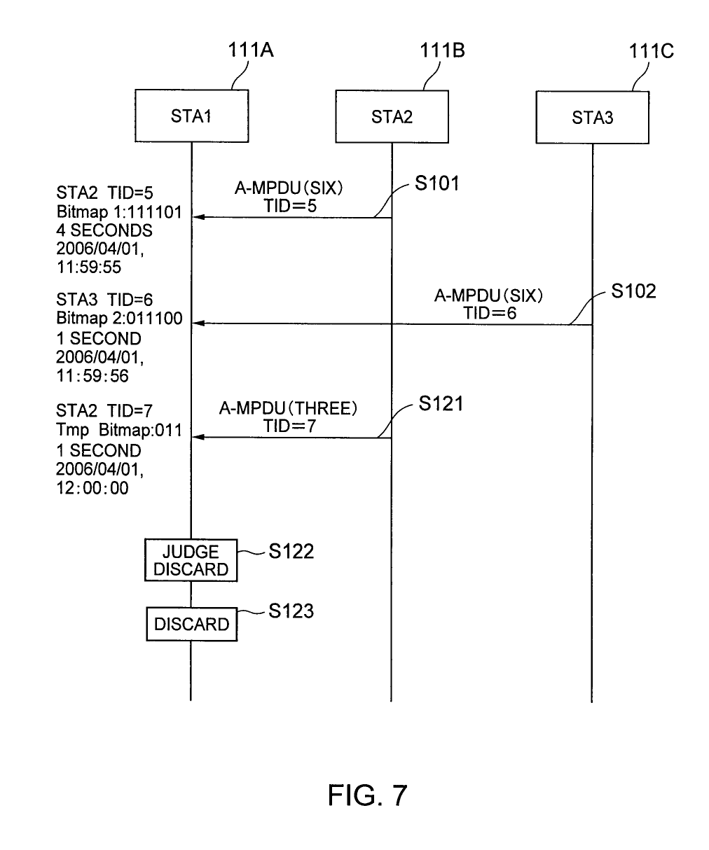

FIG. 7 is a sequence chart concerning a fourth specific example of the radio communication processing. In FIG. 7, the STA1 is a receiver of frame sequences, and the STA2 and the STA3 are transmitters of frame sequences. The fourth specific example is a modification of the first specific example. Concerning the fourth specific example, differences from the first specific example will be mainly described.

First, an A-MPDU frame including six QoS data frames of TID=5 is created in the STA2 and transmitted from the STA2 to the STA1 (S101). It is assumed that the frame length of each QoS data frame of the A-MPDU frame is 50 Octets. The STA1 receives this A-MPDU frame via an antenna and analyzes the received A-MPDU frame. A result of the analysis is notified to the discard judging unit 311 of the STA1.

Next, the discard judging unit 311 judges that, among held bitmaps, there is no bitmap both of whose transmission source address and TID coincide with those of the A-MPDU frame. Subsequently, the discard judging unit 311 judges that there is a free memorizing area in the bitmap memorizing areas 321 of the STA1, and memorizes a reception result “111101” in the bitmap memorizing area 321-1 (bitmap 1). In the memorizing unit 301 of the STA1, the transmission source address (STA2), the data type of the data frames (TID=5), the allowable delay time of the A-MPDU frame (4 seconds), and the last update time of the bitmap in the bitmap 1 (2006/04/01, 11:59:55) are memorized as information incidental to the bitmap in the bitmap 1. The allowable delay time and the last update time may be a result acquired by the frame receiving unit 203 and notified to the discard judging unit 311 by the frame receiving unit 203, or may be a result acquired by the discard judging unit 311 itself.

Next, an A-MPDU frame including six QoS data frames of TID=6 is created in the STA3 and transmitted from the STA3 to the STA1 (S102). It is assumed that the frame length of each QoS data frame of the A-MPDU frame is 1000 Octets. The STA1 receives this A-MPDU frame via an antenna and analyzes the received A-MPDU frame. A result of the analysis is notified to the discard judging unit 311 of the STA1.

Next, the discard judging unit 311 judges that, among held bitmaps, there is no bitmap both of whose transmission source address and TID coincide with those of the A-MPDU frame. Subsequently, the discard judging unit 311 judges that there is a free memorizing area in the bitmap memorizing areas 321 of the STA1, and memorizes a reception result “011100” in the bitmap memorizing area 321-2 (bitmap 2). In the memorizing unit 301 of the STA1, the transmission source address (STA3), the data type of the data frames (TID=6), the allowable delay time of the A-MPDU frame (1 second), and the last update time of the bitmap in the bitmap 2 (2006/04/01, 11:59:56) are memorized as information incidental to the bitmap in the bitmap 2. The allowable delay time and the last update time may be a result acquired by the frame receiving unit 203 and notified to the discard judging unit 311 by the frame receiving unit 203, or may be a result calculated by the discard judging unit 311 itself.

Next, an A-MPDU frame including three QoS data frames of TID=7 is created in the STA2 and transmitted from the STA2 to the STA1 (S121). It is assumed that the frame length of each QoS data frame of the A-MPDU frame is 50 Octets. The STA1 receives this A-MPDU frame via an antenna and analyzes the received A-MPDU frame. A result of the analysis is notified to the discard judging unit 311 of the STA1.

Next, the discard judging unit 311 judges that, among held bitmaps, there is no bitmap both of whose transmission source address and TID coincide with those of the A-MPDU frame. Subsequently, since there is no free memorizing area in the bitmap memorizing areas 321 of the STA1, the discard judging unit 311 judges that it is necessary to discard a held bitmap, and selects a bitmap memorizing area 321 from which a bitmap is discarded (S122). Specific details of S122 will be described below. A reception result “011” of the A-MPDU frame of TID=7 is temporarily held by the discard judging unit 311 until S123 as a provisional bitmap, together with the transmission source address (STA2), the data type of the QoS data frames (TID=7), the allowable delay time of the A-MPDU frame (1 second), and the last update time of the provisional bitmap (2006/04/01, 12:00:00). The allowable delay time and the last update time may be a result acquired by the frame receiving unit 203 and notified to the discard judging unit 311 by the frame receiving unit 203, or may be a result acquired by the discard judging unit 311 itself.

<4-1>

In S122, for example, the discard judging unit 311 acquires, concerning each of bitmaps memorized in the memorizing unit 301, the last update time. Then, the discard judging unit 311 selects, based on the last update time, a bitmap memorizing area 321 from which a bitmap is discarded. Here, the discard judging unit 311 acquires, as the last update time, the last update time memorized in the memorizing unit 301 as information incidental to each bitmap.

The last update time of the bitmap in the bitmap 1 is 2006/04/01, 11:59:55, and the last update time of the bitmap in the bitmap 2 is 2006/04/01, 11:59:56. Therefore, the discard judging unit 311 here instructs the discard controlling unit 312 of the STA1, to discard the bitmap in the bitmap 1 having the earliest last update time. According to the instruction, the discard controlling unit 312 discards the bitmap in the bitmap 1 and its incidental information from the memorizing unit 301 of the STA1 (S123).

Subsequently, the discard judging unit 311 memorizes the reception result “011” of the A-MPDU frame of TID=7 in the bitmap 1. In the memorizing unit 301 of the STA1, the transmission source address (STA2), the data type of the QoS data frames (TID=7), the allowable delay time of the received A-MPDU frame (1 second), and the last update time of the bitmap in the bitmap 1 (2006/04/01, 12:00:00) are memorized as information incidental to the bitmap in the bitmap 1.

In S122, for example, the discard judging unit 311 may acquire, concerning each of bitmaps memorized in the memorizing unit 301, the elapsed time from the last update and select, based on the elapsed time, a bitmap memorizing area 321 from which a bitmap is discarded. In this case, the discard judging unit 311 instructs the discard controlling unit 312 of the STA1, to discard the bitmap in the bitmap 1 having the longest elapsed time from the last update.

As described above, the radio communication apparatus 101 in this example acquires, concerning each of bitmaps memorized in the memorizing unit 301, an update time or an elapsed time from update and selects, based on the update time or the elapsed time, a bitmap memorizing area 321 from which a bitmap is discarded. Here, in the former case, a bitmap memorizing area 321 containing a bitmap having the earliest update time, is selected as a bitmap memorizing area 321 from which a bitmap is discarded. Here, in the latter case, a bitmap memorizing area 321 containing a bitmap having the longest elapsed time from update, is selected as a bitmap memorizing area 321 from which a bitmap is discarded.

Advantages of the processing in this example are the same as those of the processing in the first specific example, if an early update time or a long elapsed time from update is read as an absence of update. However, whereas a selection criterion concerning whether update is performed is a qualitative selection criterion, a selection criterion of the update time or the elapsed time from update is a quantitative criterion. Therefore, when the quantitative selection criterion is more desirable than the qualitative selection criterion, this example is more useful.

<4-2>

In S122, for example, the discard judging unit 311 may acquire, concerning each of bitmaps memorized in the memorizing unit 301, the allowable delay time of the received A-MPDU frame. Then, the discard judging unit 311 may select, based on the allowable delay time, a bitmap memorizing area 321 from which a bitmap is discarded. Here, the discard judging unit 311 acquires, as the allowable delay time, the allowable delay time memorized in the memorizing unit 301 as information incidental to each bitmap.

The allowable delay time of the A-MPDU frame in the bitmap in the bitmap 1 is 4 seconds, and the allowable delay time of the A-MPDU frame in the bitmap in the bitmap 2 is 1 second. On the other hand, the elapsed time from the last update of the bitmap in the bitmap 1 is 5 seconds (12:00:00-11:59:55), and the elapsed time from the last update of the bitmap in the bitmap 2 is 4 seconds (12:00:00-11:59:56). Therefore, the elapsed time from the last update of the bitmap in the bitmap 1 exceeds the allowable delay time of update by 1 second (5 seconds−4 seconds), and the elapsed time from the last update of the bitmap in the bitmap 2 exceeds the allowable delay time of update by 3 seconds (4 seconds−1 second). Therefore, the discard judging unit 311 here instructs the discard controlling unit 312 of the STA1, to discard the bitmap in the bitmap 2 whose elapsed time from the last update exceeds the allowable delay time by the longest time. According to the instruction, the discard controlling unit 312 discards the bitmap in the bitmap 2 and its incidental information from the memorizing unit 301 of the STA1 (S123).

Subsequently, the discard judging unit 311 memorizes the reception result “011” of the A-MPDU frame of TID=7 in the bitmap 2. In the memorizing unit 301 of the STA1, the transmission source address (STA2), the data type of the QoS data frames (TID=7), the allowable delay time of the received A-MPDU frame (1 second), and the last update time of the bitmap in the bitmap 2 (2006/04/01, 12:00:00) are memorized as information incidental to the bitmap in the bitmap 2.

As described above, the radio communication apparatus 101 in this example acquires, concerning each of bitmaps memorized in the memorizing unit 301, an allowable delay time of the received A-MPDU frame and selects, based on the allowable delay time, a bitmap memorizing area 321 from which a bitmap is discarded. Here, a bitmap memorizing area 321 from which a bitmap is discarded, is selected based on an elapsed time from update and an allowable delay time. In addition, a bitmap memorizing area 321 containing a bitmap whose elapsed time from update exceeds the allowable delay time by the longest time, is selected as a bitmap memorizing area 321 from which a bitmap is discarded.

It is highly likely that a bitmap whose elapsed time from the last update exceeds the allowable delay time by long time is already unnecessary on the transmission side, and it is less necessary to hold the bitmap on the reception side. Therefore, it is possible to preferentially keep a bitmap necessary on the transmission side, by preferentially discarding a bitmap whose elapsed time from the last update exceeds the allowable delay time by long time. In this way, in this example, a limited number of bitmap memorizing areas 321 are efficiently used.

In addition, since it is highly likely that a bitmap whose elapsed time from the last update exceeds the allowable delay time by long time is already unnecessary on the transmission side, it is less likely that its block ack request frame is sent from the transmission side. Therefore, it is possible to reduce retransmissions of data frames, by preferentially discarding a bitmap whose elapsed time from the last update exceeds the allowable delay time by long time. Consequently, in this example, time during which a radio transmission path is occupied by retransmissions of data frames is reduced and throughput is improved.

In S122, for example, the discard judging unit 311 may select a bitmap memorizing area 321 containing a bitmap having the longest allowable delay time, as a bitmap memorizing area 321 from which a bitmap is discarded. In this case, the discard judging unit 311 instructs the discard controlling unit 312 of the STA1, to discard the bitmap in the bitmap 1 having the longest allowable delay time.

Concerning a bitmap having a short allowable delay time, if the bitmap is discarded and retransmission of data frames is requested, it is highly likely that the allowable delay time is not satisfied. On the other hand, concerning a bitmap having a long allowable delay time, even if the bitmap is discarded and retransmission of data frames is requested, it is highly likely that the allowable delay time is satisfied. This scheme is effective, for example, when the difference in the allowable delay time is large between bitmaps.

### Fifth Specific Example

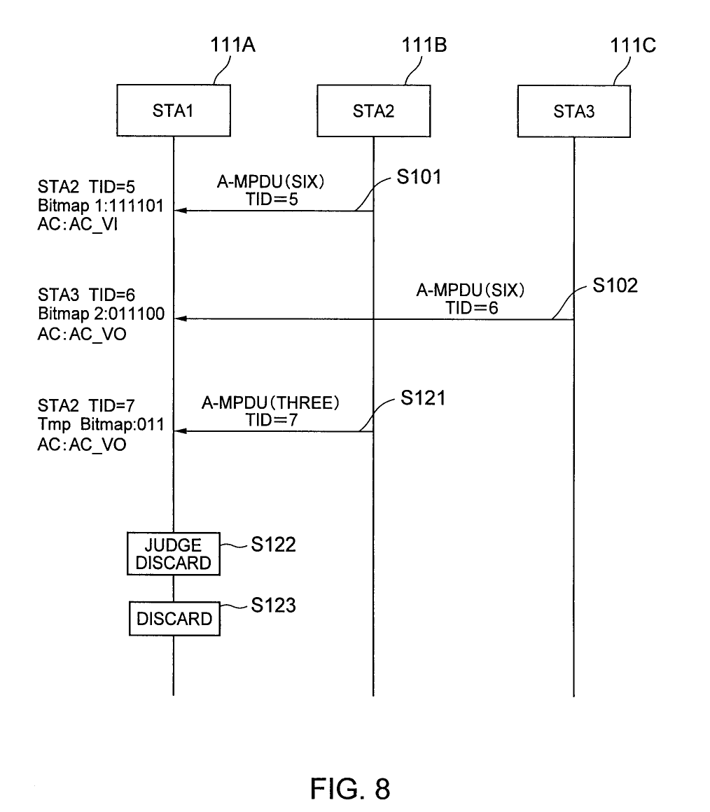

FIG. 8 is a sequence chart concerning a fifth specific example of the radio communication processing. In FIG. 8, the STA1 is a receiver of frame sequences, and the STA2 and the STA3 are transmitters of frame sequences. The fifth specific example is a modification of the first specific example. Concerning the fifth specific example, differences from the first specific example will be mainly described.

First, an A-MPDU frame including six QoS data frames of TID=5 is created in the STA2 and transmitted from the STA2 to the STA1 (S101). The STA1 receives this A-MPDU frame via an antenna and analyzes the received A-MPDU frame. A result of the analysis is notified to the discard judging unit 311 of the STA1.

Next, the discard judging unit 311 judges that, among held bitmaps, there is no bitmap both of whose transmission source address and TID coincide with those of the A-MPDU frame. Subsequently, the discard judging unit 311 judges that there is a free memorizing area in the bitmap memorizing areas 321 of the STA1, and memorizes a reception result “111101” in the bitmap memorizing area 321-1 (bitmap 1). In the memorizing unit 301 of the STA1, the transmission source address (STA2) and the data type of the data frames (TID=5) are memorized as information incidental to the bitmap in the bitmap 1.

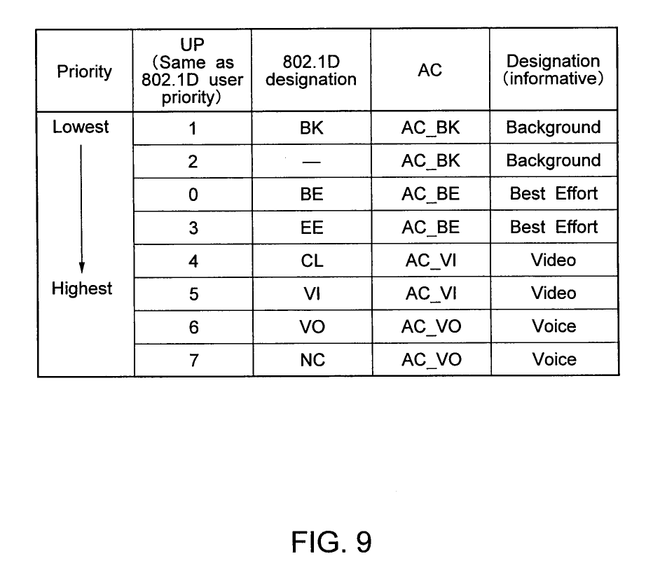

Moreover, the discard judging unit 311 deduces the traffic type of the A-MPDU frame (AC=AC_VI) from the data type of the A-MPDU frame (TID=5), with reference to a correspondence table in FIG. 9 defined in, for example, IEEE802.11e. The traffic type of the A-MPDU frame (AC=AC_VI) is also memorized in the memorizing unit 301 of the STA1, as information incidental to the bitmap of the bitmap 1.

Next, an A-MPDU frame including six QoS data frames of TID=6 is created in the STA3 and transmitted from the STA3 to the STA1 (S102). The STA1 receives this A-MPDU frame via an antenna and analyzes the received A-MPDU frame. A result of the analysis is notified to the discard judging unit 311 of the STA1.

Next, the discard judging unit 311 judges that, among held bitmaps, there is no bitmap both of whose transmission source address and TID coincide with those of the A-MPDU frame. Subsequently, the discard judging unit 311 judges that there is a free memorizing area in the bitmap memorizing areas 321 of the STA1, and memorizes a reception result “011100” in the bitmap memorizing area 321-2 (bitmap 2). In the memorizing unit 301 of the STA1, the transmission source address (STA3) and the data type of the data frames (TID=6) are memorized as information incidental to the bitmap in the bitmap 2.

Moreover, the discard judging unit 311 deduces the traffic type of the A-MPDU frame (AC=AC_VO) from the data type of the A-MPDU frame (TID=6), with reference to the correspondence table in FIG. 9. The traffic type of the A-MPDU frame (AC=AC_VO) is also memorized in the memorizing unit 301 of the STA1, as information incidental to the bitmap of the bitmap 2.

Next, an A-MPDU frame including three QoS data frames of TID=7 is created in the STA2 and transmitted from the STA2 to the STA1 (S121). The STA1 receives this A-MPDU frame via an antenna and analyzes the received A-MPDU frame. A result of the analysis is notified to the discard judging unit 311 of the STA1.

Next, the discard judging unit 311 judges that, among held bitmaps, there is no bitmap both of whose transmission source address and TID coincide with those of the A-MPDU frame. Subsequently, since there is no free memorizing area in the bitmap memorizing areas 321 of the STA1, the discard judging unit 311 judges that it is necessary to discard a held bitmap, and selects a bitmap memorizing area 321 from which a bitmap is discarded (S122). Specific details of S122 will be described below. A reception result “011” of the A-MPDU frame of TID=7 is temporarily held by the discard judging unit 311 until S123 as a provisional bitmap, together with the transmission source address (STA2) and the data type of the QoS data frames (TID=7).

Moreover, the discard judging unit 311 deduces the traffic type of the A-MPDU frame (AC=AC_VO) from the data type of the A-MPDU frame (TID=7), with reference to the correspondence table in FIG. 9. The traffic type of the A-MPDU frame (AC=AC_VO) is also temporarily held by the discard judging unit 311 until S123.

<5-1>

In S122, for example, the discard judging unit 311 acquires, concerning each of bitmaps memorized in the memorizing unit 301, the traffic type of the received A-MPDU frame. Then, the discard judging unit 311 selects, based on the traffic type, a bitmap memorizing area 321 from which a bitmap is discarded.

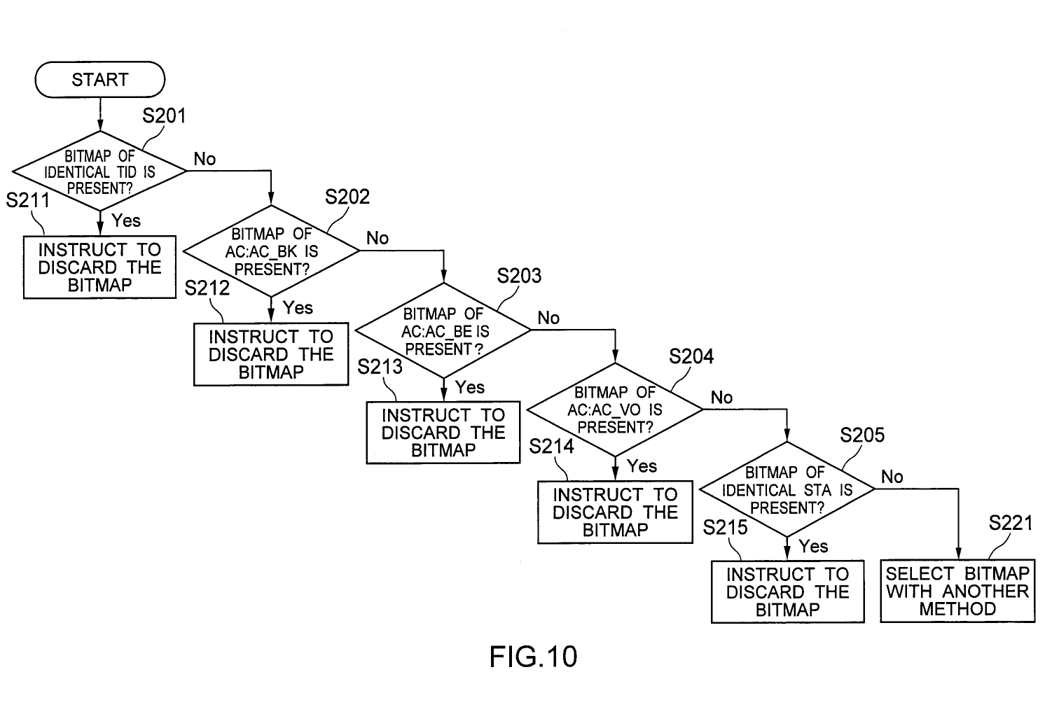

Processing in 5-1 is executed in a procedure shown in FIG. 10.

First, the discard judging unit 311 judges whether a bitmap which is provided with the identical data type with the provisional bitmap is present or not, among the bitmaps memorized in the memorizing unit 301 (S201). When such a bitmap is present, the bitmap memorizing area 321 in which the bitmap is memorized, is selected as a bitmap memorizing area 321 from which a bitmap is discarded (S211). When such a bitmap is not present, the processing proceeds to S202.

Next, the discard judging unit 311 judges whether a bitmap whose traffic type is AC_BK is present or not, among the bitmaps memorized in the memorizing unit 301 (S202). When such a bitmap is present, the bitmap memorizing area 321 in which the bitmap is memorized, is selected as a bitmap memorizing area 321 from which a bitmap is discarded (S212). When such a bitmap is not present, the processing proceeds to S203.

Next, the discard judging unit 311 judges whether a bitmap whose traffic type is AC_BE is present or not, among the bitmaps memorized in the memorizing unit 301 (S203). When such a bitmap is present, the bitmap memorizing area 321 in which the bitmap is memorized, is selected as a bitmap memorizing area 321 from which a bitmap is discarded (S213). When such a bitmap is not present, the processing proceeds to S204.

Next, the discard judging unit 311 judges whether a bitmap whose traffic type is AC_VO is present or not, among the bitmaps memorized in the memorizing unit 301 (S204). When such a bitmap is present, the bitmap memorizing area 321 in which the bitmap is memorized, is selected as a bitmap memorizing area 321 from which a bitmap is discarded (S214). When such a bitmap is not present, the processing proceeds to S205.

Next, the discard judging unit 311 judges whether a bitmap which is received from the identical radio communication apparatus 111 with the provisional bitmap is present or not, among the bitmaps memorized in the memorizing unit 301 (S205). When such a bitmap is present, the bitmap memorizing area 321 in which the bitmap is memorized, is selected as a bitmap memorizing area 321 from which a bitmap is discarded (S215). When such a bitmap is not present, the processing proceeds to S221.

Then, when a bitmap memorizing area 321 from which a bitmap is discarded is not selected through the processing, the discard judging unit 311 selects, with some other method, a bitmap memorizing area 321 from which a bitmap is discarded (S211). For example, the discard judging unit 311 may select, with any one of the methods in the first to the fourth specific examples, a bitmap memorizing area 321 from which a bitmap is discarded.

Here, the traffic type of the A-MPDU frame in the bitmap in the bitmap 1 is AC_VI, and the traffic type of the A-MPDU frame in the bitmap in the bitmap 2 is AC_VO. Therefore, as it is evident from FIG. 10, the discard judging unit 311 here instructs the discard controlling unit 312 of the STA1, to discard the bitmap in the bitmap 2. According to the instruction, the discard controlling unit 312 discards the bitmap in the bitmap 2 and its incidental information, from the memorizing unit 301 of the STA1 (S123).

Subsequently, the discard judging unit 311 memorizes the reception result “011” of the A-MPDU frame of TID=7 in the bitmap 2. In the memorizing unit 301 of the STA1, the transmission source address (STA2), the data type of the QoS data frames (TID=7), and the traffic type of the A-MPDU frame (VC=AC_VO) are memorized as information incidental to the bitmap in the bitmap 2.

As described above, the radio communication apparatus 101 in this example acquires, concerning each of bitmaps memorized in the memorizing unit 301, the traffic type of the received A-MPDU frame and selects, based on the traffic type, a bitmap memorizing area 321 from which a bitmap is discarded.

According to this example, it is possible to guarantee QoS according to a control of data based on QoS information. Moreover, it is possible to reduce data types compared with those in original QoS information, by complying with information mapped from the QoS information incidental to the data. Moreover, it is possible to realize various kinds of discard judgment processing without complicating discard judgment processing, by reducing the data types compared with those in the original QoS information.

The various specific examples of the radio communication processing executed by the radio communication apparatus 111 have been described. This embodiment is applicable to not only a wireless (radio) communication system but also a wired communication system, as long as a selective retransmission scheme is adopted as a communication scheme.

The invention is not limited to the embodiments and specific examples per se. At an implementation stage, it is possible to modify and embody the elements of the invention without departing from the spirit thereof. It is possible to form various inventions according to appropriate combinations of the plural elements disclosed in the embodiments and specific examples. For example, several elements may be deleted from all the elements described in the embodiments and specific examples. Moreover, the elements described in the different embodiments and specific examples may be combined appropriately.

As described above, embodiments of the present invention provide, with regard to a radio communication apparatus and a radio communication method for handling receipt confirmation information, techniques for efficiently using receipt confirmation information memorizing areas.

What is claimed is:

1. A radio communication apparatus that performs radio communication with another radio communication apparatus, the radio communication apparatus comprising:
a frame receiving unit configured to receive a frame including one or more data frames, from the another radio communication apparatus;
a memorizing unit configured to be capable of securing two or more receipt confirmation information memorizing areas, each of the receipt confirmation information memorizing areas being a memorizing area for memorizing receipt confirmation information of the frame and being a common memorizing area for memorizing receipt confirmation information of frames from plural radio communication apparatuses;
a receipt-confirmation-request-frame receiving unit configured to receive a receipt confirmation request frame for requesting receipt confirmation of the frame, from the another radio communication apparatus;
a receipt-confirmation-response-frame creating unit configured to create a receipt conformation response frame for responding to the receipt confirmation request frame, using the receipt confirmation information memorized in the memorizing unit;
a receipt-confirmation-response-frame transmitting unit configured to transmit the receipt confirmation response frame to the another radio communication apparatus;
a discard judging unit configured to judge whether the receipt confirmation information memorized in the memorizing unit is discarded, and to select a receipt confirmation information memorizing area from which the receipt confirmation information is discarded; and
a discard controlling unit configured to discard the receipt confirmation information from the receipt confirmation information memorizing area.

2. The apparatus according to claim 1, wherein the discard judging unit
selects a receipt confirmation information memorizing area from which the receipt confirmation information is discarded, based on whether update of the receipt confirmation information is performed.

3. The apparatus according to claim 1, wherein the discard judging unit
acquires, concerning each of pieces of the receipt confirmation information memorized in the memorizing unit, the number of correctly received data frames, and
selects, based on the number, a receipt confirmation information memorizing area from which the receipt confirmation information is discarded.

4. The apparatus according to claim 1, wherein the discard judging unit
acquires, concerning each of pieces of the receipt confirmation information memorized in the memorizing unit and the receipt confirmation information of a newly received frame, the number of correctly received data frames, and
selects, based on the number, a receipt confirmation information memorizing area from which the receipt confirmation information is discarded, or determines, based on the number, to discard the receipt confirmation information of the newly received frame.

5. The apparatus according to claim 1, wherein the discard judging unit
acquires, concerning each of pieces of the receipt confirmation information memorized in the memorizing unit, the total length of correctly received data frames, and
selects, based on the total length, a receipt confirmation information memorizing area from which the receipt confirmation information is discarded.

6. The apparatus according to claim 1, wherein the discard judging unit
acquires, concerning each of pieces of the receipt confirmation information memorized in the memorizing unit and the receipt confirmation information of a newly received frame, the total length of correctly received data frames, and
selects, based on the total length, a receipt confirmation information memorizing area from which the receipt confirmation information is discarded, or determines, based on the total length, to discard the receipt confirmation information of the newly received frame.

7. The apparatus according to claim 1, wherein the discard judging unit
acquires, concerning each of pieces of the receipt confirmation information memorized in the memorizing unit, the ratio of the total length of correctly received data frames to the total length of received data frames, and
selects, based on the ratio, a receipt confirmation information memorizing area from which the receipt confirmation information is discarded.

8. The apparatus according to claim 1, wherein the discard judging unit
acquires, concerning each of pieces of the receipt confirmation information memorized in the memorizing unit and the receipt confirmation information of a newly received frame, the ratio of the total length of correctly received data frames to the total length of received data frames, and
selects, based on the ratio, a receipt confirmation information memorizing area from which the receipt confirmation information is discarded, or determines, based on the ratio, to discard the receipt confirmation information of the newly received frame.

9. The apparatus according to claim 1, wherein the discard judging unit
acquires, concerning each of pieces of the receipt confirmation information memorized in the memorizing unit, the total length of received data frames, and
selects, based on the total length, a receipt confirmation information memorizing area from which the receipt confirmation information is discarded.

10. The apparatus according to claim 1, wherein the discard judging unit
acquires, concerning each of pieces of the receipt confirmation information memorized in the memorizing unit and the receipt confirmation information of a newly received frame, the total length of received data frames, and
selects, based on the total length, a receipt confirmation information memorizing area from which the receipt confirmation information is discarded, or determines, based on the total length, to discard the receipt confirmation information of the newly received frame.

11. The apparatus according to claim 1, wherein the discard judging unit
acquires, concerning each of pieces of the receipt confirmation information memorized in the memorizing unit, the total reception time of correctly received data frames, and
selects, based on the total reception time, a receipt confirmation information memorizing area from which the receipt confirmation information is discarded.

12. The apparatus according to claim 1, wherein the discard judging unit
acquires, concerning each of pieces of the receipt confirmation information memorized in the memorizing unit and the receipt confirmation information of a newly received frame, the total reception time of correctly received data frames, and
selects, based on the total reception time, a receipt confirmation information memorizing area from which the receipt confirmation information is discarded, or determines, based on the total reception time, to discard the receipt confirmation information of the newly received frame.

13. The apparatus according to claim 1, wherein the discard judging unit
acquires, concerning each of pieces of the receipt confirmation information memorized in the memorizing unit, the total reception time of received data frames, and
selects, based on the total reception time, a receipt confirmation information memorizing area from which the receipt confirmation information is discarded.

14. The apparatus according to claim 1, wherein the discard judging unit
acquires, concerning each of pieces of the receipt confirmation information memorized in the memorizing unit and the receipt confirmation information of a newly received frame, the total reception time of received data frames, and
selects, based on the total reception time, a receipt confirmation information memorizing area from which the receipt confirmation information is discarded, or determines, based on the total reception time, to discard the receipt confirmation information of the newly received frame.

15. The apparatus according to claim 1, wherein the discard judging unit
acquires, concerning each of pieces of the receipt confirmation information memorized in the memorizing unit, an update time or an elapsed time from update, and
selects, based on the update time or the elapsed time, a receipt confirmation information memorizing area from which the receipt confirmation information is discarded.

16. The apparatus according to claim 1, wherein the discard judging unit
acquires, concerning each of pieces of the receipt confirmation information memorized in the memorizing unit, an allowable delay bound of the received frame, and
selects, based on the allowable delay bound, a receipt confirmation information memorizing area from which the receipt confirmation information is discarded.

17. The apparatus according to claim 1, wherein the discard judging unit
acquires, concerning each of pieces of the receipt confirmation information memorized in the memorizing unit, the traffic type of the received frame, and
selects, based on the traffic type, a receipt confirmation information memorizing area from which the receipt confirmation information is discarded.

18. The apparatus according to claim 1, further comprising:
a setting-discard-frame creating unit configured to create, triggered by the discard of the receipt confirmation information from the receipt confirmation information memorizing area, a setting discard frame for discarding a setting of selective retransmission; and
a setting-discard-frame transmitting unit configured to transmit the setting discard frame to another radio communication apparatus.

19. The apparatus according to claim 1, wherein
the discard judging unit performs prioritization, triggered by the discard of the receipt confirmation information from the receipt confirmation information memorizing area, the reception of the receipt confirmation request frame, the transmission of the receipt confirmation response frame, or elapse of a certain time, for discarding the receipt confirmation information from a certain receipt confirmation information memorizing area, and
the discard control unit discards, in accordance with the prioritization, the receipt confirmation information from the certain receipt confirmation information memorizing area.

20. A radio communication method executed by a radio communication apparatus that performs radio communication with another radio communication apparatus, the radio communication method comprising:
receiving a frame including one or more data frames, from the another radio communication apparatus;
memorizing receipt confirmation information of the frame in a memorizing unit, which is configured to be capable of securing two or more receipt confirmation information memorizing areas, each of the receipt confirmation information memorizing areas being a memorizing area for memorizing receipt confirmation information of the frame and being a common memorizing area for memorizing receipt confirmation information of frames from plural radio communication apparatuses;
receiving a receipt confirmation request frame for requesting receipt confirmation of the frame, from the another radio communication apparatus;
creating a receipt conformation response frame for responding to the receipt confirmation request frame, using the receipt confirmation information memorized in the memorizing unit;
transmitting the receipt confirmation response frame to the another radio communication apparatus;
judging whether the receipt confirmation information memorized in the memorizing unit is discarded, and selecting a receipt confirmation information memorizing area from which the receipt confirmation information is discarded; and
discarding the receipt confirmation information from the receipt confirmation information memorizing area.
